(19) United States
(12) Patent Application Publication
(10) Pub. No.: US 2017/0362400 A1
(43) Pub. Date: Dec. 21, 2017

(54) OPTICAL FILM, METHOD OF MANUFACTURING THE OPTICAL FILM, POLARIZING PLATE USING THE OPTICAL FILM, AND IMAGE DISPLAY DEVICE

(71) Applicant: FUJIFILM Corporation, Tokyo (JP)

(72) Inventors: Fumitake MITOBE, Kanagawa (JP); Shinya WATANABE, Kanagawa (JP); Katsumi SASATA, Kanagawa (JP); Hajime NAKAYAMA, Kanagawa (JP)

(73) Assignee: FUJIFILM Corporation, Tokyo (JP)

(21) Appl. No.: 15/674,097

(22) Filed: Aug. 10, 2017

Related U.S. Application Data
(62) Division of application No. 14/978,164, filed on Dec. 22, 2015.

(30) Foreign Application Priority Data
Dec. 24, 2014 (JP) 2014-260518
Sep. 29, 2015 (JP) 2015-192240

(51) Int. Cl. C08J 5/18; G02B 1/14; G02B 5/30; G02F 1/1335

(52) U.S. Cl. CPC C08J 5/18; G02B 5/3033; G02B 1/14; G02B 5/3083; C08J 2345/00; G02F 1/133528

(57) ABSTRACT

There is provided an optical film including: a layer A containing a cyclic olefin-based resin; and a layer B containing a cyclic olefin-based resin, and having a thickness thinner than a thickness of the layer A, wherein a glass transition temperature Tg[B] of the layer B is lower than a glass transition temperature Tg[A] of the layer A.

### CROSS REFERENCE TO RELATED APPLICATION(S)

This application claims priority from Japanese Patent Application Nos. 2014-260518 filed on Dec. 24, 2014, and 2015-192240 filed on Sep. 29, 2015, the entire disclosures of which are incorporated herein by reference.

### BACKGROUND

### 1. Technical Field

The present invention relates to an optical film, a polarizing plate using the optical film, a method of manufacturing the optical film, and an image display device.

### 2. Background Art

In recent years, a liquid crystal display device has been widely used in applications such as a television, a personal computer, a mobile phone, and a digital camera. In general, the liquid crystal display device has a liquid crystal panel member in which polarizing plates are provided at both sides of a liquid crystal cell, and performs a display by controlling a light from a backlight member by the liquid crystal panel member. Here, the polarizing plate includes a polarizer and at least one optical film as a protective film (a polarizing plate protective film). A general polarizer is obtained by staining a stretched polyvinyl alcohol (PVA)-based film with an iodine or dichroic dye. As for the protective film, a film using various thermoplastic resins has been used.

As for the thermoplastic resin film used for the polarizing plate protective film, it has been suggested to use a cyclic olefin-based resin film as the polarizing plate protective film.

Since the polarizing plate protective film is integrated with a polarizer as described above when used as the polarizing plate, an adhesion between the polarizing plate protective film and the polarizer is important. In a case of an actual use in a liquid crystal display device, a configuration in which a polarizing plate is bonded to a liquid crystal cell is employed. Here, it becomes important that the polarizing plate protective film and the polarizer are not easily peeled in a practical test such as a peeling test of a polarizing plate.

A cyclic olefin-based resin has a characteristic of a high glass transition temperature (hereinafter, which may be referred to as Tg) due to rigidity of a main chain structure, and for example, those described in Japanese Patent Laid-Open Publication No. H1-132625, Japanese Patent Laid-Open Publication No. H 1-132626, Japanese Patent Laid-Open Publication No. S63-218726, Japanese Patent Laid-Open Publication No. S63-218726, Japanese Patent Laid-Open Publication No. H 2-133413, Japanese Patent Laid-Open Publication No. S61-120816, and Japanese Patent Laid-Open Publication No. S61-115912 may be exemplified. These various cyclic olefin-based resins may be used as an optical film or a polarizing plate protective film.

In Japanese Patent Laid-Open Publication No. S61-115912, Japanese Patent Laid-Open Publication No. 2012-177890, Japanese Patent Laid-Open Publication No. 2006-178191, an adhesion of a cyclic olefin-based resin film will be described.

In the descriptions of Japanese Patent Laid-Open Publication No. 2012-177890, a mixed organic solvent containing an organic solvent that makes a change in a cycloolefin-based resin by getting in contact with the cycloolefin-based resin is brought in contact with the cycloolefin-based resin to perform a treatment such that a haze value does not exceed 0.5%, and the resin is bonded to a polarizer.

In Japanese Patent Laid-Open Publication No. 2006-178191, descriptions are made on a method of manufacturing a polarizing plate in which at least one surface of a substrate made of a norbornene-based resin is subjected to a plasma treatment, and a polarizer is bonded to the surface which has been subjected to the plasma treatment.

In Japanese Patent Laid-Open Publication No. 2012-159665, descriptions are made on a technology of stretching and heating a norbornene-based resin film to selectively decrease a plane orientation coefficient of the surface.

However, when a cyclic olefin-based resin is used in an optical film or a polarizing plate protective film, properties of an obtained polymer are uniformly determined due to a characteristic of a used cyclic olefin. Thus, in many cases, due to a brittle film property, and insufficient adhesion with a polarizer, there is a limitation to cope with demand characteristics as a polarizing plate protective film.

Meanwhile, as for the cyclic olefin, various copolymer compositions may be selected through ring-opening copolymerization, so that a resin characteristic is controlled, and the above described brittleness can be improved. However, in this case, in general, in a resin, a low glass transition temperature (Tg) may be low, and there is a possibility that a heat-resistance may be reduced, especially, an absolute value of a dimensional change as a film may be increased.

Also, as described in Patent Documents 7 and 9, when a cyclic olefin-based resin film and a polarizer are bonded to each other, the surface of the cyclic olefin-based resin film is generally subjected to a corona treatment.

However, in considerations of, for example, a use under a further severe condition, it may be required to further improve an adhesion with the polarizer.

When a cyclic olefin-based resin film also serves as a function of an optically compensatory film of a liquid crystal display device, in view of retardation adjustment or the like of a film, the film may be stretched. However, the film may be easily torn by stretching, and the adhesion with the polarizer may be degraded.

Descriptions of Patent Document 8 include a plasma treatment, but not include retardation of a film. Through studies of the present inventors, it was found that when the cyclic olefin-based resin film described in Patent Document 8 is simply stretched, the adhesion with the polarizer is degraded even through the plasma treatment is performed.

An object of the present invention is to provide an optical film which has a high moisture resistance, an excellent adhesion with a polarizer, and a high Tg and thus has a small absolute value of a dimensional change, a polarizing plate having the optical film and a polarizer, a method of manufacturing the optical film, and an image display device using the polarizing plate.

The inventors of the present invention have conducted intensive studies, and as a result, found that in a case of using an optical film containing a cyclic olefin-based resin as a polarizing plate protective film, the problems may be solved because when a layer using a cyclic olefin-based resin with a relative low Tg is provided to a side to be adhered to a polarizer, in the polarizing plate protective film, an adhesion with the polarizer is high, Tg of the polarizing plate protective film as a whole is not excessively lowered, and a high heat resistance, especially a low absolute value of a dimensional change may be achieved. Also, in another aspect, they found that in the optical film having a glass transition temperature is 150° C. or more which contains the cyclic olefin-based resin, when at least one surface of the optical film is controlled to have specific ranges of a plane orientation coefficient and a surface hydroxyl group content, the above described problems may be solved.

### SUMMARY

(1) An optical film including: a layer A containing a cyclic olefin-based resin; and a layer B containing a cyclic olefin-based resin, and having a thickness thinner than a thickness of the layer A, wherein a glass transition temperature Tg[B] of the layer B is lower than a glass transition temperature Tg[A] of the layer A.

(2) The optical film of (1), wherein the optical film satisfies Tg[A]−Tg[B]≧5(° C.).

(3) The optical film of (1) or (2), wherein the optical film satisfies Tg[A]≧150(° C.).

(4) The optical film of any one of (1) to (3), wherein a weight average molecular weight of the cyclic olefin-based resin of the layer A is 40,000 or more.

(5) The optical film of any one of (1) to (4), wherein at least one layer of the layer A and the layer B contains a compound having a molecular weight of 10,000 or less.

(6) The optical film of any one of (1) to (5), wherein the optical film includes, as the layer B, a first layer B and a second layer B, and the first layer B, the layer A, and the second layer B are included in this order.

(7) The optical film of any one of (1) to (6), wherein an absolute value of a dimensional change before and after the optical film is left for 24 hours in an environment of 120° C. and RH of less than 5% is less than 0.2%.

(8) A method of manufacturing the optical film of any one of (1) to (7), including: film-forming simultaneously or sequentially the layer A and the layer B by a solution film-forming method.

(9) An optical film including a cyclic olefin-based resin, wherein a glass transition temperature of the optical film is 150° C. or more, a retardation in a thickness-direction of the optical film at a wavelength of 590 nm is 80 nm or more, and a plane orientation coefficient of at least one surface of the optical film is 1.0×10⁻³ or less, and a surface hydroxyl group content of the surface is 1.5% or more.

(10) A method of manufacturing the optical film of (9), including: stretching the optical film containing the cyclic olefin-based resin, and bringing the optical film into contact with a solvent so that a plane orientation coefficient of the surface is 1.0×10⁻³ or less.

(11) The method of manufacturing the optical film of (9) or (10), including: stretching the optical film containing the cyclic olefin-based resin, and performing a plasma treatment on the optical film so that a surface hydroxyl group content of the surface is 1.5% or more.

(12) A polarizing plate including the optical film of any one of (1) to (7) and (9), and a polarizer.

(13) An image display device including the polarizing plate of (12).

According to the present invention, it is possible to provide an optical film which has a high moisture resistance, an excellent adhesion with a polarizer, and a high Tg and thus has a small absolute value of a dimensional change, a polarizing plate having the optical film and a polarizer, a method of manufacturing the optical film, and an image display device using the polarizing plate.

### BRIEF DESCRIPTION OF THE DRAWINGS

FIG. 1 is a cross-sectional view illustrating an example of an atmospheric pressure plasma treatment apparatus that may be used for a plasma treatment.

FIG. 2 is a cross-sectional view illustrating an example of an apparatus of continuously performing a vacuum plasma treatment.

FIG. 3 is a cross-sectional view illustrating an example of a plasma treatment apparatus with a flame treatment.

### DETAILED DESCRIPTION OF EXEMPLARY EMBODIMENTS

### First Embodiment

An optical film according to a first embodiment of the present invention is an optical film which includes a layer A containing a cyclic olefin-based resin, and a layer B that contains a cyclic olefin-based resin and has a thickness thinner than that of the layer A, in which of a glass transition temperature Tg[B] of the layer B is lower than a glass transition temperature Tg[A] of the layer A.

The layer A is a layer containing a cyclic olefin-based resin in which a preferred content of the cyclic olefin-based resin is 50 mass % or more, more preferably 65 mass % or more, further preferably 80 mass % or more with respect to the total mass of the layer A.

The preferred range of the content of the cyclic olefin-based resin in the layer B is the same as described above.

In view of improving the adhesion with the polarizer, the glass transition temperature Tg[A] of the layer A and the glass transition temperature Tg[B] of the layer B may preferably satisfy Tg[A]−Tg[B]≧5(° C.), and more preferably satisfy Tg[A]−Tg[B]≧10(° C.).

In view of a durability at a high temperature, especially of a reduction of an absolute value of a dimensional change, it is preferred to satisfy Tg[A]≧150(° C.), and more preferred to satisfy Tg[A]≧155(° C.).

A Tg of the layer A used in the present invention preferably ranges from 150° C. to 300° C., more preferably from 155° C. to 275° C. especially preferably from 160° C. to 250° C. Within the range above, a dimensional stability at a high temperature is improved, and a moldability is also improved. A Tg of the layer B preferably ranges from 50° C. to 145° C., more preferably from 60° C. to 140° C., especially preferably from 70° C. to 135° C. Within the range above, a surface deformation due to an external force may be suppressed, and an adhesion with a polarizer may be improved.

(Measurement Method of Glass Transition Temperature (Tg))

A Tg of each layer may be measured by using a differential scanning calorimeter after cutting out a film and taking out a single film member of each layer. Specifically, the measurement was performed using a differential scanning calorimeter DSC7000X (manufactured by Hitachi High-Tech Science Inc.) under conditions of a nitrogen atmosphere, and a heating rate of 20° C./min, and a peak top temperature of a time differential scanning calorimetry (DSC) curve (DDSC curve) of the obtained result was obtained, and a temperature at a point where a tangent of each DSC curve intersects at the peak top temperature of −20° C. was obtained as Tg.

An absolute value of a dimensional change before and after the optical film of the present invention is left for 24 hours in an environment of 120° C. and RH 5% is preferably less than 0.2%.

In the cyclic olefin-based resin film layers A and B used in the present invention, a film thickness of the layer A is thicker than that of the layer B. The film thickness of all layers preferably ranges from 5 μm to 200 μm, more preferably from 10 μm to 100 μm, and also preferably from 15 μm to 80 μm especially for the application of an image display device. The ratio of the film thickness of the layer B in the film thickness of all layers preferably ranges from 0.1% to 40%, more preferably from 0.5% to 20%, especially from 1% to 10%. By this arrange, it is possible to achieve both the dimensional stability of the layered film at a high temperature and a polarizer adhesion.

The layer A and the layer B are preferably directly layered on top of each other but may be bonded through an adhesive or the like. Example of a method of directly layering the layer A and the layer B on top of each other may include a method of simultaneously casting layers on a metal support as disclosed in Japanese Patent Laid-Open Publication No. H11-198285, and a method of firstly casting one side layer, and then sequentially casting the other layer. Otherwise, after a film formed of only one side layer is manufactured, the other layer film may be applied or casted on the one side layer. A single layer A and a single layer B may be layered, or three or more layers of layer B-layer A-layer B may be layered. In a case of three or more layers, it is preferred that at least one outermost layer becomes a layer B.

The optical film of the present invention may preferably have a first layer B and a second layer B as for the layer B, and include the first layer B, the layer A, and the second layer B in this order. The first layer B and the second layer B may be same or different.

In the cyclic olefin-based resin used for the present invention, a number average molecular weight (Mn) in terms of polystyrene measured by gel permeation chromatography (GPC) preferably ranges from 12,000 to 100,000, more preferably from 16,000 to 80,000, especially preferably from 20,000 to 50,000. A weight average molecular weight (Mw) of the cyclic olefin-based resin is preferably 40,000 or more, and more preferably ranges from 40,000 to 300,000, further preferably from 60,000 to 250,000, especially preferably from 80,000 to 200,000.

When the number average molecular weight and the weight average molecular weight are within the above ranges, a water resistance, a chemical resistance, and mechanical properties of the cyclic olefin-based resin, and a moldability of the cyclic olefin-based resin as an optical film are improved.

(Measurement of Molecular Weight)

GPC: gel permeation chromatography apparatus (HLC-8220 GPC (manufactured by Tosoh Corporation), column; guard column HXL-H, TSK gel G7000HXL, TSK gel GMHXL (two), TSK gel G2000HXL which are sequentially connected (manufactured by Tosoh Corporation), eluent; tetrahydrofuran, flow rate; 1 mL/min, sample concentration; 0.7 wt % to 0.8 wt %, sample injection volume; 70 μL, measurement temperature; 40° C., detector; RI (40° C.), standard substance; TSK standard polystyrene (manufactured by Tosoh Corporation)) was used to measure a weight average molecular weight (Mw) in terms of standard polystyrene and a molecular weight distribution (Mw/Mn). Mn is a number average molecular weight in terms of standard polystyrene.

(Cyclic Olefin-Based Resin)

As a cyclic olefin-based resin used for the optical film of the present invention, following (co)polymers may be exemplified.

(1) a ring-opening polymer or a ring-opening copolymer of a specific monomer represented by Formula (I) below.

(2) a ring-opening copolymer of a specific monomer represented by Formula (I) below and a copolymerizable monomer.

(3) a hydrogenated (co)polymer of a ring-opening (co)polymer of (1) or (2) above.

(4) a hydrogenated (co)polymer obtained by cyclization of a ring-opening (co)polymer of (1) or (2) above through a Friedel-Crafts reaction.

(5) a saturated copolymer of a specific monomer represented by Formula (I) above and an unsaturated double bond-containing compound.

(6) an addition-type copolymer of a specific monomer represented by Formula (I) above and at least one kind of monomer selected from a vinyl based cyclic hydrocarbon monomer, and a cyclopentadiene monomer, and a hydrogenated (co)polymer thereof.

(7) an alternating copolymer of a specific monomer represented by Formula (I) above and acrylate.

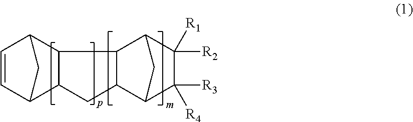

In Formula (I), R₁ to R₄ each independently represent a hydrogen atom, a halogen atom, or a monovalent organic group, and may be same or different. Any two of R₁ to R₄ may be bonded to each other to form a monocyclic or polycyclic structure. m is 0 or a positive integer, and p is 0 or a positive integer.

As a monovalent organic group represented by R₁ to R₄, a hydrocarbon group having 1 to 30 carbon atoms, or other monovalent organic groups may be exemplified.

<Specific Monomer>

Specific examples of the specific monomer represented by Formula (I) above may include following compounds, but the present invention is not limited to these specific examples.
Bicyclo[2.2.1]hept-2-ene,
tricyclo[4.3.0.1^{2,5}]-3-decene,
tricyclo[4.4.0.1^{2,5}]-3-undecene,
tetracyclo[4.4.0.1^{2,5}.1^{7,10}]-3-dodecene,
pentacyclo[6.5.1.1^{3,6}.0^{2,7}.0^{9,13}]-4-pentadecene,
5-methylbicyclo[2.2.1]hept-2-ene,
5-ethylbicyclo[2.2.1]hept-2-ene,
5-methoxycarbonylbicyclo[2.2.1]hept-2-ene,
5-methyl-5-methoxycarbonylbicyclo[2.2.1]hept-2-ene,
5-cyanobicyclo[2.2.1]hept-2-ene,
8-methoxycarbonyltetracyclo[4.4.0.1^{2,5}.1^{7,10}]-3-dodecene,
8-ethoxycarbonyltetracyclo[4.4.0.1^{2,5}.1^{7,10}]-3-dodecene,
8-n-propoxycarbonyltetracyclo[4.4.0.1^{2,5}.1^{7,10}]-3-dodecene,
8-isopropoxycarbonyltetracyclo[4.4.0.1^{2,5}.1^{7,10}]-3-dodecene,
8-n-butoxycarbonyltetracyclo[4.4.0.1^{2,5}.1^{7,10}]-3-dodecene,
8-methyl-8-methoxycarbonyltetracyclo[4.4.0.1^{2,5}.1^{7,10}]-3-dodecene,
8-methyl-8-ethoxycarbonyltetracyclo[4.4.0.1^{2,5}.1^{7,10}]-3-dodecene,
8-methyl-8-n-propoxycarbonyltetracyclo[4.4.0.1^{2,5}.1^{7,10}]-3-dodecene,
8-methyl-8-isopropoxycarbonyltetracyclo[4.4.0.1^{2,5}.1^{7,10}]-3-dodecene,
8-methyl-8-n-butoxycarbonyltetracyclo[4.4.0.1^{2,5}.1^{7,10}]-3-dodecene,
S-ethylidenebicyclo[2.2.1]hept-2-ene,
8-ethylidenetetracyclo[4.4.0.1^{2,5}.1^{7,10}]-3-dodecene,
5-phenylbicyclo[2.2.1]hept-2-ene,
8-phenyltetracyclo[4.4.0.1^{2,5}.1^{7,10}]-3-dodecene,
5-fluorobicyclo[2.2.1]hept-2-ene,
5-fluoromethylbicyclo[2.2.1]hept-2-ene,
5-trifluoromethylbicyclo[2.2.1]hept-2-ene,
5-pentafluoroethylbicyclo[2.2.1]hept-2-ene,
5,5-difluorobicyclo[2.2.1]hept-2-ene,
5,6-difluorobicyclo[2.2.1]hept-2-ene,
5,5-bis(trifluoromethyl)bicyclo[2.2.1]hept-2-ene,
5,6-bis(trifluoromethyl)bicyclo[2.2.1]hept-2-ene,
5-methyl-5-trifluoromethylbicyclo[2.2.1]hept-2-ene,
5,5,6-trifluorobicyclo[2.2.1]hept-2-ene,
5,5,6-tris(fluoromethyl)bicyclo[2.2.1]hept-2-ene,
5,5,6,6-tetrafluorobicyclo[2.2.1]hept-2-ene,
5,5,6,6-tetrakis(trifluoromethyl)bicyclo[2.2.1]hept-2-ene,
5,5-difluoro-6,6-bis(trifluoromethyl)bicyclo[2.2.1]hept-2-ene,
5,6-difluoro-5,6-bis(trifluoromethyl)bicyclo[2.2.1]hept-2-ene,
5,5,6-trifluoro-5-trifluoromethylbicyclo[2.2.1]hept-2-ene,
5-fluoro-5-pentafluoroethyl-6,6-bis(trifluoromethyl)bicyclo[2.2.1]hept-2-ene,
5,6-difluoro-5-heptafluoro-iso-propyl-6-trifluoromethylbicyclo[2.2.1]hept-2-ene,
5-chloro-5,6,6-trifluorobicyclo[2.2.1]hept-2-ene,
5,6-dichloro-5,6-bis(trifluoromethyl)bicyclo[2.2.1]hept-2-ene,
5,5,6-trifluoro-6-trifluoromethoxybicyclo[2.2.1]hept-2-ene,
5,5,6-trifluoro-6-heptafluoropropoxybicyclo[2.2.1]hept-2-ene,
8-fluorotetracyclo[4.4.0.1^{2,5}.1^{7,10}]-3-dodecene,
8-fluoromethyltetracyclo[4.4.0.1^{2,5}.1^{7,10}]-3-dodecene,
8-difluoromethyltetracyclo[4.4.0.1^{2,5}.1^{7,10}]-3-dodecene,
8-trifluoromethyltetracyclo[4.4.0.1^{2,5}.1^{7,10}]-3-dodecene,
8-pentafluoroethyltetracyclo[4.4.0.1^{2,5}.1^{7,10}]-3-dodecene,
8,8-difluorotetracyclo[4.4.0.1^{2,5}.1^{7,10}]-3-dodecene,
8,9-difluorotetracyclo[4.4.0.1^{2,5}.1^{7,10}]-3-dodecene,
8,8-bis(trifluoromethyl)tetracyclo[4.4.0.1^{2,5}.1^{7,10}]-3-dodecene,
8,9-bis(trifluoromethyl)tetracyclo[4.4.0.1^{2,5}.1^{7,10}]-3-dodecene,
8-methyl-8-trifluoromethyltetracyclo[4.4.0.1^{2,5}.1^{7,10}]-3-dodecene,
8,8,9-trifluorotetracyclo[4.4.0.1^{2,5}.1^{7,10}]-3-dodecene,
8,8,9-tris(trifluoromethyl)tetracyclo[4.4.0.1^{2,5}.1^{7,10}]-3-dodecene,
8,8,9,9-tetrafluorotetracyclo[4.4.0.1^{2,5}.1^{7,10}]-3-dodecene,
8,8,9,9-tetrakis(trifluoromethyl)tetracyclo[4.4.0.1^{2,5}.1^{7,10}]-3-dodecene,
8,8-difluoro-9,9-bis(trifluoromethyl)tetracyclo[4.4.0.1^{2,5}.1^{7,10}]-3-dodecene,
8,9-difluoro-8,9-bis(trifluoromethyl)tetracyclo[4.4.0.1^{2,5}.1^{7,10}]-3-dodecene,
8,8,9-trifluoro-9-trifluoromethyltetracyclo[4.4.0.1^{2,5}.1^{7,10}]-3-dodecene,
8,8,9-trifluoro-9-trifluoromethoxytetracyclo[4.4.0.1^{2,5}.1^{7,10}]-3-dodecene,
8,8,9-trifluoro-9-pentafluoropropoxytetracyclo[4.4.0.1^{2,5}.1^{7,10}]-3-dodecene,
8-fluoro-8-pentafluoroethyl-9,9-bis(trifluoromethyl)tetracyclo[4.4.0.1^{2,5}.1^{7,10}]-3-dodecene,
8,9-difluoro-8-heptafluoro iso-propyl-9-trifluoromethyltetracyclo[4.4.0.1^{2,5}.1^{7,10}]-3-dodecene,
8-chloro-8,9,9-trifluorotetracyclo[4.4.0.1^{2,5}.1^{7,10}]-3-dodecene,
8,9-dichloro-8,9-bis(trifluoromethyl)tetracyclo[4.4.0.1^{2,5}.1^{7,10}]-3-dodecene,
8-(2,2,2-trifluoroethoxycarbonyl)tetracyclo[4.4.0.1^{2,5}.1^{7,10}]-3-dodecene,
8-methyl-8-(2,2,2-trifluoroethoxycarbonyl)tetracyclo[4.4.0.1^{2,5}.1^{7,10}]-3-dodecene and the like may be exemplified.

These may be used singly or in combinations of two or more thereof.

In a preferred specific monomer, in Formula (I) above, R₁ and R₃ each represent a hydrogen atom or a hydrocarbon group having 1 to 10 carbon atoms, further preferably 1 to 4 carbon atoms and especially preferably 1 to 2 carbon atoms, R₂ and R₄ each represent a hydrogen atom or a monovalent organic group, in which at least one of R₂ and R₄ represents a hydrogen atom or a polar group having polarity other than a hydrocarbon group, m is an integer of 0 to 3, p is an integer of 0 to 3, more preferably m+p ranges from 0 to 4, further preferably from 0 to 2, especially preferably m=1, p=0. A specific monomer in which m=1, p=0 is preferable in that an obtained cyclic olefin-based resin has a high glass transition temperature and an excellent mechanical strength.

As a polar group of the specific monomer, a carboxyl group, a hydroxyl group, an alkoxycarbonyl group, allyloxycarbonyl group, an amino group, an amide group, a cyano group and the like may be exemplified, and these polar groups may be bonded via a linking group such as a methylene group. A hydrocarbon group or the like in which a divalent polar organic group such as a carbonyl group, an ether group, a silyl ether group, a thioether group, or an imino group is bonded as a linking group may be exemplified as a polar group. Among these, a carboxyl group, a hydroxyl group, an alkoxycarbonyl group or an allyloxycarbonyl group is preferred, and in particular, an alkoxycarbonyl group or an allyloxycarbonyl group is preferred.

A monomer in which at least one of R₂ and R₄ is a polar group represented by formula —(CH₂)ₙCOOR is preferable in that an obtained cyclic olefin-based resin has a high glass transition temperature and a low moisture absorption. In the formula about the specific polar group, R is a hydrocarbon group having 1 to 12 carbon atoms, further preferably 1 to 4 carbon atoms and especially preferably 1 to 2 carbon atoms, and preferably is an alkyl group. n generally ranges from 0 to 5, but n having a smaller value is preferred in that an obtained cyclic olefin-based resin has a higher glass transition temperature. A specific monomer in which n is 0 is preferred in terms of easy synthesis.

In Formula (I) above, R₁ or R₃ is preferably an alkyl group, or an alkyl group having 1 to 4 carbon atoms, further preferably an alkyl group having 1 to 2 carbon atoms, and specially preferably a methyl group. In particular, it is preferred that the alkyl group is bonded to the same carbon atom as a carbon atom to which a specific polar group represented by the above formula —(CH₂)ₙCOOR is bonded, because an obtained cyclic olefin-based resin has a low moisture absorption.

(Copolymerizable Monomer)

Specific examples of the copolymerizable monomer may include cycloolefins such as cyclobutene, cyclopentene, cycloheptene, cyclooctene, dicyclopentadiene, tetracyclododecene, and methanotetrahydrofluorene. The number of carbon atoms of the cycloolefin preferably ranges from 4 to 20, more preferably from 5 to 12. These may be used singly or in combinations of two or more thereof.

<Ring-Opening Polymerization Catalyst>

In the present invention, a ring-opening polymerization reaction for obtaining (1) a ring-opening polymer of a specific monomer, and (2) a ring-opening copolymer of a specific monomer and a copolymerizable monomer is performed in the presence of a metathesis catalyst.

The metathesis catalyst is a catalyst having a combination of (a) at least one kind selected from compounds of W, Mo and Re, and (b) at least one kind selected from compounds of Deming periodic table Group IA elements (e.g., Li, Na, K), group IIA elements (e.g., Mg, Ca), group IIB elements (e.g., Zn, Cd, Hg), group IIIA elements (e.g., B, Al), group IVA elements (e.g., Si, Sn, Pb), or group IVB elements (e.g., Ti, Zr), the compounds each having at least one element-carbon bond or element-hydrogen bond. In this case, in order to enhance the activity of a catalyst, (c) an additive to be described below may be added.

Representative examples of the compound of W, Mo or Re suitable for (a) the component may include compounds such as WCl₆, MoCl₆, ReOCl₃ described in Japanese Patent Laid-Open Publication No. H1-132626 (page 8, 6^{th} line of lower left column to 17^{th} line of upper right column).

Specific examples of (b) the component may include compounds such as n-C₄H₉Li, (C₂H₅)₃Al, (C₂H₅)₂AlCl, (C₂H₅)1.5 AlCl_{1.5}, (C₂H₅)AlCl₂, methylalumoxane, LiH described in Japanese Patent Laid-Open Publication No. H1-132626 (page 8, 18^{th} line of upper right column to 3^{th} line of lower right column).

As representative examples of (c) the component as an additive, alcohols, aldehydes, ketones, amines, and the like may be properly used, and also compounds described in Japanese Patent Laid-Open Publication No. H1-132626 (page 8, 16^{th} line of lower right column to page 9, 17^{th} line of upper left column) may be used.

The usage amount of the metathesis catalyst is set such that a molar ratio of “the (a) component and the specific monomer” ranges generally from 1:500 to 1:50,000, and preferably from 1:1,000 to 1:10,000.

The ratio of the (a) component and the (b) component, that is, (a):(b), ranges from 1:1 to 1:50, and preferably from 1:2 to 1:30 in a metal atomic ratio.

The ratio of the (a) component and the (c) component, that is, (c):(a), ranges from 0.005:1 to 15:1, preferably from 0.05:1 to 7:1 in a molar ratio.

<Polymerization Reaction Solvent>

As a solvent used for a ring-opening polymerization reaction (a solvent constituting a molecular weight modifier solution, a specific monomer and/or metathesis catalyst solvent), for example, alkanes such as pentane, hexane, heptane, octane, nonane, and decane, cycloalkanes such as cyclohexane, cycloheptane, cyclooctane, decalin, and norbornane, aromatic hydrocarbons such as benzene, toluene, xylene, ethylbenzene, and cumene, compounds of halogenated alkanes, aryl halides or the like such as chlorobutane, bromohexane, methylene chloride, dichloroethane, hexamethylene dibromide, chlorobenzene, chloroform, and tetrachloroethylene, saturated carboxylic acid esters such as ethyl acetate, n-butyl acetate, iso-butyl acetate, methyl propionate, dimethoxyethane, ethers such as dibutyl ether, tetrahydrofuran, dimethoxyethane, and the like may be exemplified, These may be used singly or in combinations of two or more thereof. Among them, an aromatic hydrocarbon is preferred.

The use amount of the solvent may be set such that “solvent:specific monomer (mass ratio)” ranges generally from 1:1 to 10:1, and preferably from 1:1 to 5:1.

<Molecular Weight Modifier>

An adjustment of a molecular weight of an obtained ring-opening (co)polymer may be performed depending on the polymerization temperature, type of catalyst, the kind of the solvent, but in the present invention, is performed by allowing a molecular weight modifier to coexist in a reaction system.

Here, as a suitable molecular weight modifier, for example, α-olefins and styrenes such as ethylene, propene, 1-butene, 1-pentene, 1-hexene, 1-heptene, 1-octene, 1-nonene, and 1-decene may be exemplified, and among them, 1-butene and 1-hexene are particularly preferred.

These molecular weight modifiers may be used singly or in combinations of two or more thereof.

The molecular weight modifier is used in an amount of 0.005 mol to 0.6 mol, preferably from 0.02 mol to 0.5 mol, with respect to 1 mol of a specific monomer provided to a ring-opening polymerization reaction.

In order to obtain (2) the ring-opening copolymer, in a ring-opening polymerization process, a specific monomer and a copolymerizable monomer may be subjected to a ring-opening copolymerization, but a specific monomer may be subjected to a ring-opening polymerization in the presence of an unsaturated hydrocarbon polymer or the like which contains two or more carbon-carbon double bonds in a main chain, e.g., a conjugated diene compound such as polybutadiene or polyisoprene, a styrene-butadiene copolymer, an ethylene-non-conjugated diene copolymer, and a polynorbornene.

The ring-opening (co)polymer obtained as described above may be used as it is, but (3) a hydrogenated (co)polymer obtained by further hydrogenating the ring-opening (co)polymer is useful as a raw material for a resin having a high impact resistance.

<Hydrogenation Catalyst>

The hydrogenation reaction is carried out by a conventional method, that is, by adding a hydrogenation catalyst to a solution of a ring-opening polymer, and applying a hydrogen gas ranging from normal pressure to 300 atm, preferably from 3 atm to 200 atm at 0° C. to 200° C., preferably at 20° C. to 180° C.

As for the hydrogenation catalyst, a catalyst that is used for a hydrogenation reaction of a conventional olefinic compound may be used. As the hydrogenation catalyst, a heterogeneous catalyst and a homogenous catalyst may be exemplified.

As a heterogeneous catalyst, a solid catalyst in which a precious metal catalyst material such as palladium, platinum, nickel, rhodium, or ruthenium, is supported on a carrier such as carbon, silica, alumina, titania may be exemplified. As a homogeneous catalyst, nickel naphthenate/triethylaluminum, nickel acetylacetonate/triethylaluminum, cobalt octenoate/n-butyl lithium, titanocene dichloride/diethylaluminum monochloride, rhodium acetate, chlorotris (triphenylphosphine) rhodium, dichlorotris (triphenylphosphine) ruthenium, chloro hydrocarbonyl tris (triphenylphosphine) ruthenium, dichloro carbonyltris(triphenylphosphine) ruthenium and the like may be exemplified. The form of the catalyst may be either a powder form or a particulate form.

A usage ratio of such a hydrogenation catalyst is set such that ring-opening (co)polymer:hydrogenation catalyst (mass ratio) ranges from 1:1×10-6 to 1:2.

The hydrogenated copolymer obtained by hydrogenation as described above has an excellent thermal stability, and the property is not deteriorated even by heating when the hydrogenated copolymer is molded or used as a product. Here, the hydrogenated rate is usually 50% or more, preferably 70% or more, further preferably 90% or more.

The hydrogenated rate of the hydrogenated (co)polymer, that is, the value measured by 500 MHz, 1H-NMR, is 50% or more, preferably 90% or more, further preferably 98% or more, most preferably 99% or more. The higher the hydrogenated rate is, the more excellent the stability in heat or light becomes, and when the optical film of the present invention is used as a wavelength plate, a stable property may be obtained over a long period of time.

In the hydrogenated (co)polymer used as the cyclic olefin-based resin of the present invention, a gel content included in the hydrogenated (co)polymer is preferably 5 mass % or less, particularly preferably 1 mass % or less.

As the cyclic olefin-based resin of the present invention, (4) a (co)polymer obtained by cyclizing a ring-opening (co)polymer of (1) or (2) above through a Friedel-Crafts reaction and hydrogenating the cyclized (co)polymer may also be used.

<Cyclization by Friedel-Crafts Reaction>

A method of cyclizing the ring-opening (co)polymer of (1) or (2) through a Friedel-Crafts reaction is not particularly limited, but a conventionally known method using an acidic compound described in Japanese Patent Laid-Open Publication No. S50-154399 may be employed. As the acidic compound, specifically, Lewis acids and Bronstead acids, such as AlCl₃, BF₃, FeCl₃, Al₂O₃, HCl, CH₃ClCOOH, zeolite, and activated clay, are used.

The cyclized ring-opening (co)polymer may be hydrogenated in the same manner as that for the ring-opening (co)polymer of (1) or (2).

As the cyclic olefin-based resin of the present invention, (5) a saturated copolymer of the specific monomer and an unsaturated double bond-containing compound also may be used.

<Unsaturated Double Bond-Containing Compound>

As an unsaturated double bond-containing compound, for example, olefin compounds such as ethylene, propylene, butene, having preferably 2 to 12 carbon atoms, further preferably 2 to 8 carbon atoms may be exemplified.

A preferred usage range of the specific monomer/unsaturated double bond-containing compound ranges from 90/10 to 40/60 by a mass ratio, further preferably from 85/15 to 50/50.

In the present invention, in order to obtain (5) the saturated copolymer of the specific monomer and the unsaturated double bond-containing compound, a conventional addition polymerization method may be used.

<Addition Polymerization Catalyst>

As a catalyst for synthesizing (5) the saturated copolymer, at least one kind selected from a titanium compound, a zirconium compound and a vanadium compound, and an organoaluminum compound as a cocatalyst are used.

Here, as the titanium compound, titanium tetrachloride, titanium trichloride and the like may be exemplified, and as the zirconium compound, bis(cyclopentadienyl) zirconium chloride, bis (cyclopentadienyl) zirconium dichloride, and the like may be exemplified.

As the vanadium compound, a vanadium compound represented by a formula of VO(OR)aXb, or V(OR)cXd [here, R is a hydrocarbon group, X is a halogen atom, 0≦a≦3, 0≦b≦3, 2≦(a+b)≦3, 0≦c≦4, 0≦d≦4, 3≦(c+d)≦4] or an electron donor adducts thereof is used.

As the electron donor, alcohols, phenols, ketone, aldehyde, carboxylic acid, esters of organic acid or inorganic acid, ether, acid amide, acid anhydride, an oxygen-containing electron donor such as alkoxysilane, a nitrogen-containing electron donor such as ammonia, amine, nitrile, or isocyanate, and the like may be exemplified.

As the organoaluminum compound as a cocatalyst, at least one kind selected from compounds having at least one aluminum-carbon bond or aluminum-hydrogen bond is used.

In the above description, in a case where, for example, a vanadium compound is used, in a ratio of a vanadium compound and an organoaluminum compound, a ratio of aluminum atoms with respect to vanadium atoms (Al/V) is 2 or more, and preferably ranges from 2 to 50, especially preferably from 3 to 20.

The polymerization reaction solvent used for the addition polymerization may be the same as a solvent used for the ring-opening polymerization reaction. An adjustment of a molecular weight of (5) the obtained saturated copolymer is generally performed using hydrogen.

As the cyclic olefin-based resin of the present invention, (6) an addition-type copolymer of the specific monomer and at least one kind of monomer selected from a vinyl based cyclic hydrocarbon monomer, and a cyclopentadiene monomer, and a hydrogenated copolymer thereof may be used.

<Vinyl Based Cyclic Hydrocarbon Monomer>

As the vinyl based cyclic hydrocarbon monomer, for example, a vinylated 5-membered ring hydrocarbon monomer, e.g., a vinylcyclopentene monomer such as 4-vinylcyclopentene, or 2-methyl-4-isopropenylcyclopentene, and a vinylcyclopentane monomer such as 4-vinylcyclopentane, or 4-isopropenylcyclopentane, a vinylcyclohexene monomer such as 4-vinylcyclohexene, 4-isopropenylcyclohexene, 1-methyl-4-isopropenylcyclohexene, 2-methyl-4-vinylcyclohexene, or 2-methyl-4-isopropenylcyclohexene, a vinylcyclohexane monomer such as 4-vinylcyclohexane or 2-methyl-4-isopropenylcyclohexane, a styrene monomer such as styrene, α-methylstyrene, 2-methylstyrene, 3-methylstyrene, 4-methylstyrene, 1-vinylnaphthalene, 2-vinylnaphthalene, 4-phenylstyrene, or p-methoxystyrene, a terpene monomer such as d-terpene, l-terpene, diterpene, d-limonene, l-limonene, or dipentene, a vinylcyclo heptene monomer such as 4-vinylcycloheptene, or 4-isopropenylcycloheptene, a vinylcyclo heptane monomer such as 4-vinylcycloheptane, or 4-isopropenylcycloheptane and the like may be exemplified. Styrene and α-methylstyrene are preferred. These may be used singly or in combinations of two or more thereof.

<Cyclopentene Monomer>

As the cyclopentadiene monomer used for a monomer of (6) the addition-type copolymer of the present invention, for example, cyclopentadiene, 1-methylcyclopentadiene, 2-methylcyclopentadiene, 2-ethylcyclopentadiene, 5-methylcyclopentadiene, 5,5-methylcyclopentadiene and the like may be exemplified. Cyclopentadiene is preferred. These may be used singly or in combinations of two or more thereof.

The addition-type (co)polymer of the specific monomer and at least one kind of monomer selected from a vinyl based cyclic hydrocarbon monomer, and a cyclopentadiene monomer may be obtained by the same addition polymerization method as that for (5) the saturated copolymer of the specific monomer and an unsaturated double bond-containing compound.

The hydrogenated (co)polymer of the addition-type (co)polymer may be obtained by the same hydrogenation method as that for the hydrogenated (co)polymer of (3) the ring-opening (co)polymer.

As the cyclic olefin-based resin of the present invention, (7) an alternating copolymer of the specific monomer and acrylate may also be used.

<Acrylate>

As acrylate used for manufacturing (7) the alternating copolymer of the specific monomer and acrylate in the present invention, for example, a linear, branched or cyclic alkyl acrylate having 1 to 20 carbon atoms such as methylacrylate, 2-ethylhexylacrylate, or cyclohexylacrylate, a heterocyclic group-containing acrylate having 2 to 20 carbon atoms such as glycidylacrylate or 2-tetrahydrofurfuryl acrylate, an aromatic ring group-containing acrylate having 6 to 20 carbon atoms such as benzylacrylate, a polycyclic structure-containing acrylate having 7 to 30 carbon atoms such as isobornyl acrylate, or dicyclopentanyl acrylate and the like may be exemplified.

In the present invention, in order to obtain (7) the alternating copolymer of the specific monomer and acrylate, radical polymerization is carried out in the presence of a Lewis acid in which when the sum of the specific monomer and acrylate is 100 mol, on a ratio basis, generally, the specific monomer ranges from 30 mol to 70 mol, and acrylate ranges from 70 mol to 30 mol, preferably, the specific monomer ranges from 40 mol to 60 mol, and acrylate ranges from 60 mol to 40 mol, and especially preferably the specific monomer ranges from 45 mol to 55 mol, and acrylate ranges from 55 mol to 45 mol.

The amount of the Lewis acid used for obtaining (7) the alternating copolymer of the specific monomer and acrylate ranges from 0.001 mol to 1 mol with respect to 100 mol of acrylate. A conventional organic peroxide or azobis radical polymerization initiator which generates free radicals may be used, and a polymerization reaction temperature generally ranges from −20° C. to 80° C., preferably from 5° C. to 60° C. As the polymerization reaction solvent, the same as a solvent used for the ring-opening polymerization reaction may be used.

The “alternating copolymer” mentioned in the present invention indicates a copolymer having a structure in which structural units derived from the specific monomers are not adjacent to each other, that is, a structural unit derived from the specific monomer is necessarily adjacent to a structural unit derived from acrylate, but is not intended to deny a structure in which acrylate-derived structural units are adjacent to each other.

(Additive)

To the optical film of the present invention, various additives (e.g., plasticizer, retardation (optical anisotropy) adjusting agent, UV absorber, matting agent, anti-oxidant, release promoter agent) according to applications in respective preparation processes may be added. These may be solid or oily substances. That is, the melting points and boiling points are not particularly limited. For example, an UV absorbing material at 20° C. or less or 20° C. or more may be mixed, and similarly, a degradation inhibitor may be mixed. The addition time may be any time during in a cyclic olefin-based resin solution manufacturing process, but an additive-addition preparation step may be additionally performed in a final preparation step of a dope preparation process. An addition amount of each material is not particularly limited as long as its function is exhibited. When the cyclic olefin-based resin film of the present invention is formed in multi-layers, that is, when an A layer and a B layer are formed, the kinds or amounts of the additive in respective layers may be different.

In view of improving an adhesion with a polarizer, at least one layer of the layer A and the layer B may preferably include a compound having a molecular weight of 10,000 or less.

Hereinafter, each material will be described.

(Plasticizer)

A plasticizer has a function of controlling a physical property of the optical film of the present invention or improving a fluidity or flexibility of a doping solution when the doping solution has a cyclic olefin resin dissolved in a solvent. As the plasticizer, a phthalic acid ester-, fatty acid ester-, trimellitic acid ester-, phosphoric acid ester-, polyester-, or epoxy-based plasticizer may be exemplified.

(Retardation Adjusting Agent)

To the optical film of the present invention, a retardation adjusting agent may be added. As the retardation adjusting agent in the present invention, any one of an agent which exhibits retardation (hereinafter, referred to as a retardation developer) and an agent which reduces retardation (hereinafter, referred to as a retardation decreasing agent) may be preferably used.

(UV Absorber)

As a UV absorber, a benzotriazole-, 2-hydroxy benzophenone-, or phenyl salicylate ester-based absorber may be exemplified. For example, triazoles such as 2-(5-methyl-2-hydroxyphenyl)benzotriazole, 2-[2-hydroxy-3,5-bis(α,α-dimethylbenzyl)phenyl]-2H-benzotriazole, 2-(3,5-di-t-butyl-2-hydroxyphenyl)benzotriazole, and benzophenones such as 2-hydroxy-4-methoxybenzophenone, 2-hydroxy-4-octoxybenzophenone, 2,2′-dihydroxy-4-methoxybenzophenone may be exemplified.

(Matting Agent)

The optical film of the present invention may desirably contain a matting agent in view of film slipperiness, and stable production. The matting agent may be a matting agent of either an inorganic compound or an organic compound.

Examples of the matting agent of the inorganic compound may preferably include a silicon-containing inorganic compound (e.g., silicon dioxide, calcined calcium silicate, hydrated calcium silicate, aluminum silicate, magnesium silicate), titanium oxide, zinc oxide, aluminum oxide, barium oxide, zirconium oxide, strontium oxide, antimony oxide, tin oxide, tin oxide antimony, calcium carbonate, talc, clay, calcined kaolin, calcium phosphate and the like, and further preferably a silicon-containing inorganic compound or zirconium oxide. Particularly preferably, silicon dioxide is used since the turbidity of a cellulose acylate film may be reduced. As fine particles of the silicon dioxide, for example, commercially available products having product names such as Aerosil R972, R974, R812,200,300, R202, OX50, TT600 (manufactured by Nippon Aerosil Co., Ltd.) may be used. As fine particles of the zirconium oxide, for example, commercially available products having product names such as Aerosil R976 and R811 (manufactured by Nippon Aerosil Co., Ltd.) may be used.

As specific examples of the matting agent of the organic compound, for example, a silicon resin, an acrylic resin and the like are preferred. Among silicon resins, in particular, a resin having a three-dimensional network structure is preferred. For example, commercially available products having product names such as Tospearl 103, Tospearl 105, Tospearl 108, Tospearl 120, Tospearl 145, Tospearl 3120 and Tospearl 240 (manufactured by Toshiba Silicone Co.) may be used.

When such a matting agent is added to a cyclic olefin-based resin solution, any method may be employed without particular limitation as long as a desired cyclic olefin-based resin solution may be obtained. For example, in a step of mixing a cyclic olefin-based resin with a solvent, an additive may be added, and after a mixed solution of a cyclic olefin-based resin and a solvent is produced, an additive may be added. It may be added and mixed just prior to casting a dope (so-called a just-before addition method), and in the mixing, a screw-type kneading device is installed online and used. Specifically, a static mixer such as an inline mixer is preferred, and also as an inline mixer, for example, a static mixer SWJ (Toray static pipe mixer Hi-Mixer) (manufactured by Toray Engineering) is preferred. In relation to inline addition, in order to eliminate density unevenness, particle aggregation and the like, Japanese Patent Laid-Open Publication No. 2003-053752 discloses an invention in which in a method of manufacturing a cyclic olefin-based resin film, a distance L from an addition nozzle tip for mixing an additive solution of a different composition with a main raw material dope to a starting end of an inline mixer is set to be 5 times or less a main raw material pipe inner diameter d so that density unevenness, or aggregation of mat particles or the like may be eliminated. As a more preferred aspect, it is described that a distance L from a supply nozzle distal end opening of an additive solution of a different composition with a main raw material dope to a starting end of an inline mixer is set to be 10 times or less an inner diameter (d) of the supply nozzle distal end opening, and the inline mixer is a static non-agitation type pipe mixer or a dynamic agitation type pipe mixer. More specifically, it is disclosed that a flow rate ratio of a cellulose acylate film main raw material dope/an inline additive solution ranges from 10/1 to 500/1, preferably from 50/1 to 200/1. In Japanese Patent Laid-Open Publication No. 004933 for an invention of manufacturing a phase difference film excellent in slip resistance and transparency which has a low additive bleeding-out property, and no interlayer peeling phenomenon, in a method of adding an additive, the additive may be added to a melting pot, or the additive or a solution having the additive dissolved or dispersed therein may be added to a dope which is being fed between the melting pot and a co-casting die. In a latter case, it is described that in order to improve the miscibility, a mixing means such as a static mixer is preferably provided.

(Anti-Oxidant)

As an anti-oxidant, any compound may be properly added as long as it may prevent oxidation, deterioration, thermal decomposition or thermal coloration when the cyclic olefin-based resin of the present invention is molded into or used for a film. As an action mechanism for trapping or decomposing alkyl radicals or peroxide radicals generated by oxidation of a resin, an anti-oxidant suitable for each case may be added so that the effect may be expected. For example, IRGANOX-1010, IRGANOX-1076, (manufactured by BASF Corp.), SUMILIZER GM, SUMILIZER GS (manufactured by Sumitomo Chemical Co., Ltd.) and the like may be exemplified.

The additives may be used singly or in combinations of two or more thereof.

(Method of Manufacturing Film)

In the present invention, as a method of forming a film of a cyclic olefin-based resin, a solution film-forming method is preferred. In the film-forming of a resin with a high Tg, it is not necessary to perform heating and melting at high temperature, and thermal decomposition may be suppressed. It is easy to obtain a surface smoothness due to leveling of the solution.

(Solvent)

Descriptions will be made on a solvent of dissolving the cyclic olefin-based resin. As the solvent, an organic solvent is preferably used. In the present invention, an organic solvent that may be used is not particularly limited as long as it can achieve its purpose in a range where the cyclic olefin-based resin is dissolved and casted and formed into a film. As the organic solvent used in the present invention, a chlorinated solvent such as dichloromethane or chloroform, or a solvent selected from chain hydrocarbon, cyclic hydrocarbon, aromatic hydrocarbon, esters, ketones, ethers, alcohols is preferred. Esters, ketones, ethers, and alcohols may have a cyclic structure. Examples of the chain hydrocarbon may include hexane, octane, isooctane, decane, and the like. Examples of the cyclic hydrocarbon may include cyclopentane, cyclohexane, decalin and derivatives thereof. Examples of the aromatic hydrocarbon may include benzene, toluene, xylene, and the like. Examples of the esters may include ethyl formate, propyl formate, pentyl formate, methyl acetate, ethyl acetate, and pentyl acetate. Examples of the ketones may include acetone, methyl ethyl ketone, diethyl ketone, diisobutyl ketone, cyclopentanone, cyclohexanone, and methylcyclohexanone. Examples of the ethers may include diisopropyl ether, dimethoxymethane, dimethoxyethane, 1,4-dioxane, 1,3-dioxolane, tetrahydrofuran, anisole and phenetole. Examples of the organic solvent having two or more functional groups may include 2-ethoxyethyl acetate, 2-methoxyethanol and 2-butoxyethanol. Examples of alcohols may include methanol, ethanol, 1-propanol, 2-propanol, n-butanol, iso-butanol, tert-butanol and the like. A preferred boiling point of the organic solvent ranges from 35° C. to 200° C. As the solvent, one kind of solvent may be used singly, or two or more kinds of solvents may be mixed in any ratio and used.

In a range capable of maintaining the solubility, a solvent having a polar group such as a carbonyl group, a hydroxyl group or the like, represented by esters, ketones, ethers, alcohols or the like may be preferably used in combination. By using these solvents having the polar group in combination, it is possible to reduce a load in peeling from a metal support used for casting and to improve the productivity.

(Doping Concentration)

A solid concentration of the dope prepared by using the solvent may preferably range from 10 mass % to 40 mass %, and may range from 15 mass % to 35 mass %. When the concentration exceeds the range, the productivity is reduced because a load is increased at the time of dope filtration. When the dope is discharged from a die, the dope is likely to be adhered on a die lip, thereby causing streaks.

(Dissolution Method)

The dissolution method of the cyclic olefin-based resin may be, for example: a method by a room temperature stirring dissolution; a cooling dissolution method of stirring and swelling a polymer at a room temperature, cooling the polymer at a temperature of −20° C. to −100° C. and then heating and dissolving the polymer at a temperature of 20° C. to 100° C.; a high temperature dissolution method of dissolving the resin at a temperature equal to or higher than a boiling point of a main solvent in a sealed container; and a method of dissolving the resin at a high temperature and a high pressure up to a critical point of the solvent. A polymer with a good solubility is preferably dissolved at a room temperature, but a polymer with a poor solubility is heated and dissolved in a sealed container. It is desirable that for a polymer with a solubility that is not so poor, a temperature to be selected is as low as possible in order to suppress thermal decomposition of the resin or to reduce a process load.

(Filtration)

Prior to casting, a dope may be preferably filtered through a suitable filter medium such as a metal mesh or flannel to remove undissolved matter or foreign matters such as dust, impurities or the like. In the filtration of the dope, a filter with an absolute filtration accuracy ranging from 0.1 μm to 100 μm is used, and a filter with an absolute filtration accuracy ranging from 0.5 μm to 25 μm is preferably used. As the filter medium, conventionally known materials such as glass fiber, cellulose fiber, filter paper, and fluororesin such as tetrafluoroethylene resin may be preferably used, and ceramic, metal, or the like may be preferably used.

(Viscosity)

A viscosity of the dope just prior to film-forming may be within a range where the dope may be casted in the film-forming, but the dope is prepared with a viscosity generally preferably ranging from 1 Pa·s to 200 Pa·s, more preferably from 3 Pa·s to 100 Pa·s, further preferably from 5 Pa·s to 70 Pa·s. Here, the temperature is not particularly limited as long as it is a temperature at the time of casting, but preferably ranges from −5° C. to 70° C., more preferably from −5° C. to 40° C.

(Film Forming)

Descriptions will be made on a method of manufacturing a film using a cyclic olefin-based resin solution. As the method and device for manufacturing the cyclic olefin-based resin film of the present invention, the same solution casting film-forming method and solution casting film-forming apparatus as that provided to conventional manufacturing of a cellulose triacetate film is used. The dope (a cyclic olefin-based resin solution) prepared in a dissolver (pot) is stored in a storage pot once, and bubbles contained in the dope are removed so as to make a final preparation. The dope is fed from a dope discharge port to a pressure die through a pressure metering gear pump capable of quantitatively feeding a liquid with a high precision according to, for example, a rotation speed. Then, the dope is uniformly casted on an endlessly running metal support of a casting part from of a pressure die mouthpiece (slit), and at a peeling point where the metal support almost travelled one lap, a half-dry doping film (also called a web) is peeled from the metal support. While both ends of the obtained web are nipped between clips, the web is conveyed by a tenter and dried, and then is conveyed through a roll group of a drying device. Then, the drying of the web is completed and the web is wound by a winder at a predetermined length. A combination of the tenter and the drying device of the roll group is varied according to purposes. In the solution casting film-forming method used for a functional protective film for a display, besides the solution casting film-forming apparatus, a coating apparatus for processing a surface of a film (e.g., applying an undercoating layer, an antistatic layer, an antihalation layer, or a protective layer) may be added. Hereinafter, each preparation step will be simply described, but the present invention is not limited thereto.

First, when the prepared cyclic olefin-based resin solution (dope) is used to manufacture a cyclic olefin-based resin film through a solvent casting method, preferably, the dope is casted on an endless metal support, e.g., a metal drum or a metal support (band or belt) and the solvent is evaporated to form a film. The concentration of the dope prior to casting is preferably adjusted such that an amount of the cyclic olefin-based resin ranges from 10 mass % to 40 mass %. The surface of the drum or band is preferably finished in a mirror state. The dope may be preferably casted on a drum or band at a surface temperature of 30° C. or less, and in particular, the temperature of the metal support preferably ranges from −10° C. to 20° C.

Cellulose acylate film forming technologies described in Japanese Patent Laid-Open Publication Nos. 2000-301555, 2000-301558, H7-032391, H3-193316, H5-086212, S62-037113, H2-276607, S55-014201, H2-111511, and H2-208650 may be applied in the present invention.

(Casting)

A method of casting a solution may be: a method of uniformly extruding a prepared dope from a pressure die to a metal support; a method using a doctor blade in which a film thickness of a dope casted once on a metal support is adjusted by a blade; a method using a reverse roll coater in which a reversely rotating roll is used for adjustment, and the like. A method using a pressure die is preferred. As for the pressure die, a coat-hanger die or a T-die may be exemplified, and any die may be preferably used. Besides methods exemplified herein, conventionally known various methods of performing a casting and film-forming of a cellulose triacetate solution may be carried out, and each condition is set in consideration of a difference of a boiling or the like of a solvent to be used so that the same effects as those described in respective publications is obtained. As an endlessly running metal support used for manufacturing the cyclic olefin-based resin film of the present invention, a drum whose surface is mirror-finished by chromium plating or a stainless steel belt (also called band) mirror-finished by surface polishing is used. One or two or more pressure dies used for manufacturing the cyclic olefin-based resin film of the present invention may be provided above the metal support. Preferably, the number of dies may be one or two. When the two or more dies are provided, the amount of the dope to be casted may be divided at various ratios for the respective dies, and the dope may be fed to the dies from a plurality of precision metering gear pumps at respective ratios. The temperature of the cyclic olefin-based resin solution used for the casting may preferably range from −10° C. to 55° C., more preferably from 25° C. to 50° C. In this case, the temperature may be the same in all steps, or different in respective places of the steps. When the temperature is varied, the temperature may be a desired temperature just prior to casting.

(Drying on Support)

A method of drying the dope on the metal support in relation to the manufacturing of the cyclic olefin-based resin film may be: a general method of blowing a hot air from the surface side of the metal support (e.g., a drum or band), that is, the surface of the web on the metal support; a method of blowing a hot air from the back surface of the drum or band; and a liquid heat transfer method of bringing a temperature-controlled liquid in contact with the back surface at the opposite side to a dope casting surface of the band or drum so that the drum or band is heated due to heat transfer so as to control the surface temperature, but a back surface liquid heat transfer method is preferred. The surface temperature of the metal support prior to casting may be any degree as long as it is equal to or lower than a boiling point of the solvent used for the dope. However, in order to facilitate the drying, and eliminate the fluidity on the metal support, the temperature is preferably set to a temperature lower than a boiling point of a solvent having a lowest boiling point among used solvents, by 1° to 10°.

(Peeling from Metal Support)

When a half-dry film is peeled from the metal support, a large peel resistance (peel load) may cause an optically anisotropic unevenness because a film is irregularly stretched in a film forming direction. In particular, when the peel load is large, a stretched portion and an unstretched portion alternately occur in a stepped shape in the film forming direction so that a retardation distribution is made. When the film is loaded in a liquid crystal display device, a linear or strip-shaped unevenness is seen. In order to prevent an occurrence of such a problem, a peel load of the film may be preferably set to 0.25 N or less per 1 cm of a film peel width. The peel load is more preferably 0.2 N/cm or less, further preferably 0.15 N or less. The peel load of 0.2 N/cm or less is particularly preferred, because an unevenness caused by peeling is not observed at all even in a liquid crystal display device in which unevenness is likely to occur. As a method of reducing a peel load, a method of adding a releasing agent as described above, or a method of selecting a composition of a solvent to be used may be employed.

A measurement of a peel load is performed as follows. The dope is dropped on a metal plate having the same material and surface roughness as that of the metal support of the film forming apparatus, and is spread to a uniform thickness using a doctor blade and dried. Slits with an equal width are made in the film using a cutter knife, and the tip of the film is peeled by hand and is gripped by a clip connected to a strain gauge. Then, the strain gauge is raised in the oblique direction of 45° while a change in a load is measured. The volatile component content in the released film is also measured. The same measurement is repeated several times while changing a drying period, so as to determine a peel load when the residual volatile component content is the same as that upon peeling in an actual film forming process. As the peeling speed increases, the peel load tends to become larger, and thus, the measurement is preferably carried out at a peeling speed close to an actual speed.

The concentration of the residual volatile component content upon peeling preferably ranges from 5 mass % to 100 mass %, more preferably from 10 mass % to 60 mass %, particularly from 15 mass % to 40 mass %. A peeling at a high volatile component content is desirable because a drying speed may be improved and a productivity may be improved. Meanwhile, at the high volatile component content, the film has a small strength or a small elasticity and loses to a peeling force, and thus may be broken or stretched. The self-retaining force of the released film is insufficient, and thus the film is likely to suffer deformation, and formation of wrinkles and kinks. This may be a cause of generating a distribution in retardation.

(Drying)

Descriptions will be made on a method of drying a web which has been dried on a drum or belt and released. The web released at a peeling position just prior to one lap of the drum or belt may be conveyed alternately through a group of rolls arranged in a zigzag state, or may be conveyed in a non-contact manner while both ends of the released web are nipped by clips or the like.

In the manufacturing method of the present invention, in the movement section from the peeling step to the stretching step, the film may pass preferably through three or more pass rolls with a wrap angle of at least 60° or more, more preferably through five or more pass rolls, and particularly preferably through 7 to 51 pass rolls. In the manufacturing method of the present invention, as the above described pass roll with a wrap angle of 60° or more, at least one dancer is preferably included. The number of the dancer is preferably one. The wrap angle in the present specification refers to a size of a central angle connecting a circular arc region where the film wraps the roll to the roll center. For example, in a case where the film passes through the rolls arranged in a complete zigzag state, the wrap angle becomes 180°.

The drying is performed by a method of exposing both surfaces of the web (film) during conveyance to a wind at a predetermined temperature or a method of adopting a heating means or the like such as microwaves. In the case of rapid drying, there is a concern that the planarity of the formed film is impaired. Thus, it is preferable that at an initial stage of the drying, the film is dried at a temperature such that the solvent does not foam, and after the drying is carried out, the film is dried at a high temperature. In the drying step after the film is peeled from a support, the film tends to contract in a longitudinal direction or width direction due to evaporation of the solvent. The higher the drying temperature is, the larger the contraction is. It is desirable that the film is dried while suppressing this contraction as far as possible from the view of making the planarity of the finished film favorable. From this point of view, a method for performing the drying step entirely or partly while holding both width ends of the web by clips or pins in a width direction (tenter mode) as described in, for example, Japanese Patent Laid-Open Publication No. S62-46625, is preferred. The drying temperature in the drying step preferably ranges from 100° C. to 160° C. The drying temperature, the amount of drying wind and the drying time vary with the solvent to be used, but may be properly selected according to the kind of the solvent to be used, or a combination thereof.

(Stretching)

The manufacturing of the film of the present invention may include a step of stretching a web (film) peeled from a support. When the film of the present invention is used as a phase difference film, a phase difference may be adjusted by including a stretching step.

There is no particular limitation on the method of stretching a web, and any of a uniaxial stretching method and a biaxial stretching method may be employed. For example, a method of stretching a web in a conveying direction by making a circumferential speed difference among a plurality of rolls, and utilizing the roll circumferential speed difference among them, a method of stretching a web in a conveying direction by fixing both ends of the web with clips or pins and widening the intervals between the clips or pins in the proceeding direction, a method of stretching a web in a width direction by widening the intervals between the clips or pins in a direction perpendicular to a conveying direction, or a method of stretching a web in both the conveying direction and the width direction by widening in both the vertical and horizontal directions, or an oblique stretching method of conveying a web in the oblique direction while holding the web may be exemplified. These methods may be used in combination. A so-called tenter method is desirable because when a clip portion is driven by a linear drive mechanism, smooth stretching may be carried out, and a risk such as a rupture may be reduced. By performing this stretching, development of retardation may be adjusted.

The temperature during stretching is preferably (Tg−30° C.) or more, more preferably (Tg−10° C.) or more, and is preferably (Tg+60° C.) or less, more preferably (Tg+40° C.) or less based on a glass transition temperature Tg of the cyclic olefin-based resin film. When the cyclic olefin-based resin film is a film having a plurality of layers, the glass transition temperature Tg of the cyclic olefin-based resin may be varied according to respective layers. In this case, preferably, the temperature during the stretching is set based on a glass transition temperature Tg of a cyclic olefin-based resin which forms a layer having the lowest glass transition temperature Tg.

The stretching ratio may be properly selected depending on optical properties such as a phase difference to be expressed in a phase difference film, and is generally 5% or more, preferably 10% or more, and is generally 300% or less, preferably 150% or less.

(Winding)

Preferably, the cyclic olefin-based resin film is dried to have the residual volatile component content to 1% or less, and then is wound. Before the film is wound, a knurling treatment may be preferably performed on both ends of the film. The width of knurling ranges from 3 mm to 50 mm, more preferably from 5 mm to 30 mm, and the height ranges from 1 μm to 50 μm, preferably from 2 μm to 20 μm, more preferably from 3 μm to 10 μm. This may be one-side pushing or both-side pushing.

The width of the cyclic olefin-based resin film obtained as described above preferably ranges from 0.5 m to 3 m, more preferably from 0.6 m to 2.5 m, further preferably from 0.8 m to 2.2 m. The winding is performed so that one roll has a length ranging preferably from 100 m to 10000 m, more preferably from 500 m to 7000 m, further preferably from 1000 m to 6000 m. When the film is wound, it is preferred to provide knurling on at least one end. The width ranges from 3 mm to 50 mm, more preferably from 5 m to 30 mm, and the height ranges from 0.5 μm to 500 μm, more preferably from 1 μm to 200 μm. This may be one-side pushing or both-side pushing. As a winder for winding the obtained film, a generally used winder may be used, and the film may be wound by a winding method such as a constant-tension method, a constant-torque method, a taper tension method, and a programmed tension control method in which an internal stress is constant.

The optical film of the present invention is used as a protective film of a polarizer. Here, the optical film of the present invention may be used as a protective film for a polarizer, at a liquid crystal cell side of a liquid crystal display device and may have a function of compensating an oblique viewing angle of a liquid crystal cell, as a function of a so-called optically compensatory film (or a phase difference film). Meanwhile, it may be used as a protective film for a polarizer, at an outer side than at the liquid crystal cell. The optically compensatory film generally refers to an optical material which is used for a liquid crystal display device and compensates a phase difference, and is the same as a phase difference plate, an optically compensatory sheet or the like. The optically compensatory film has a birefringence, and is used for the purpose of removing coloration of a display screen of a liquid crystal display device, or improving a viewing angle characteristic.

(Variation of Optical Properties)

When the optical film of the present invention is used as a phase difference film, it is possible to reduce a variation of a polarization performance of a processed polarizing plate by reducing a variation of optical properties. When it is assumed that an in-plane retardation of a phase difference film is Re, and a retardation in a thickness-direction is Rth, the variation of a Re value of a total width is preferably ±5 nm, more preferably ±3 nm, and the variation of a Rth value is preferably ±10 nm, more preferably ±5 nm, particularly preferably ±3 nm. Preferably, a variation of a Re value and a Rth value in a longitudinal direction is also within a range of a variation in a width direction. In order to maintain a transparent appearance, the haze preferably ranges from 0.01% to 2%. In the cyclic olefin-based resin film roll obtained as described above, a slow axis direction of a film falls preferably within a range of ±2 degrees and preferably within a range of ±1 degree with respect to a winding direction (a longitudinal direction of a film). Alternatively, the slow axis direction falls preferably within a range of ±2 degrees and preferably within a range of ±1 degree with respect to a rectangular direction (a width direction of a film) to the winding direction. In particular, the slow axis direction of the film falls preferably within ±0.3 degrees with respect to the winding direction (the longitudinal direction of the film), or preferably within ±0.3 degrees with respect to the width direction of the film.

(Functional Layer)

In the optical film of the present invention, a functional layer with a film thickness ranging from 0.1 μm to 20 μm may be further layered on at least one side surface of the film. The kind of the functional layer is not particularly limited, but may be a hard coat layer, an anti-reflection layer (a refractive index-controlled layer such as a low refractive index layer, a medium refractive index layer, and a high refractive index layer), an antiglare layer, an antistatic layer, a ultraviolet light absorbing layer, a moisture permeability reduction layer or the like. One or more functional layers may be provided. A method of laminating the functional layer is not particularly limited, but the functional layer may be preferably provided through co-casting with a cyclic olefin-based resin composition for forming the optical film of the present invention, and may also be preferably provided by being coated on the optical film of the present invention.

Various additives may be added to a functional layer material in order to manufacture an anti-reflection layer (a refractive index-controlled layer such as a low refractive index layer, a medium refractive index layer, a high refractive index layer), an antiglare layer, an antistatic layer, a ultraviolet light absorbing layer, a moisture permeability reduction layer or the like as the functional layer.

The thickness of the functional layer more preferably ranges from 0.01 μm to 100 μm, particularly preferably from 0.02 μm to 50 μm. In a functional layer for reducing the permeability, the thickness particularly preferably ranges from 0.1 μm to 20 μm.

(Surface Treatment)

In some cases, the optical film of the present invention may be subjected to a surface treatment so as to achieve an improvement of an adhesion between the film and another layer (e.g., a polarizer, an undercoat layer and a back layer). For example, a glow discharge treatment, a UV irradiation treatment, a corona treatment, a flame treatment, or an acid or alkali treatment may be used. The glow discharge treatment mentioned herein may be a low temperature plasma treatment occurring under a low pressure gas of 10⁻³ to 20 Torr, or may be preferably a plasma treatment under atmospheric pressure. A plasma excitable gas refers to a plasma-excited gas under the condition as described above, and argon, helium, neon, krypton, xenon, nitrogen, carbon dioxide, fluorocarbons such as tetrafluoromethane, and mixtures thereof may be exemplified. These are described in detail in pp. 30 to 32 in Journal of Technical Disclosure (Kogi No. 2001-1745, issued Mar. 15, 2001, Japan Institute of Invention and Innovation), and may be preferably used in the present invention.

### Second Embodiment

An optical film of a second embodiment of the present invention is an optical film containing a cyclic olefin-based resin,

in which a glass transition temperature of the optical film is 150° C. or more,

a retardation in a thickness-direction of the optical film at a wavelength of 590 nm is 80 nm or more,

a plane orientation coefficient of at least one side surface of the optical film is 1.0×10⁻³ or less, and a surface hydroxyl group content on the surface is 1.5% or more.

As the cyclic olefin-based resin according to the second embodiment, the same cyclic olefin-based resin as that described in the above described first embodiment may be used. The same as the additives or film manufacturing method described in the first embodiment may be used in the second embodiment.

The optical film in the second embodiment may be composed of a plurality of layers as in the first embodiment, but is preferably a film of a single layer.

(Retardation)

From the viewpoint of a display performance of a liquid crystal panel, a retardation in a thickness-direction of the optical film at a wavelength of 590 nm is 80 nm or more, and preferably ranges from 80 nm to 300 nm and more preferably from 80 nm to 150 nm. An in-plane retardation of the optical film at a wavelength of 590 nm is 30 nm or more, and preferably ranges from 30 nm to 100 nm, and more preferably from 40 nm to 80 nm.

The in-plane retardation and the retardation in a thickness-direction may be adjusted by stretching or the like of the film.

A method of measuring a retardation will be described below.

Re(λ) and Rth(λ) each represent an in-plane retardation and a retardation in a thickness-direction at a wavelength λ.

In the present specification, unless otherwise indicated, the wavelength λ is defined as 590 nm. The Re(λ) is measured by making light having a wavelength of λ nm incident in a normal direction of the film in KOBRA 21ADH (manufactured by Oji Scientific Instruments). The Rth(λ) may also be calculated by KOBRA 2 IADH based on retardation values obtained by measuring the Re(λ) of a total of six points, an assumed value of an average refractive index and the input film thickness value. The retardation Re (λ) values are measured such that light having a wavelength of λ nm is made incident to the film in a direction inclined by a step of 10° to 50° at one side from a normal direction with respect to a film normal direction using an in-plane slow axis (determined by KOBRA 21ADH) as a tilt axis (rotation axis) (in a case where there is no slow axis, any direction in a film plane is taken as a rotation axis). Also, the Rth value may be calculated according to the following equations (A) and (B) based on retardation values obtained by measuring in any two directions using a slow axis as a tilt axis (rotation axis) (in a case where there is no slow axis, any direction in a film plane is taken as a rotation axis), an assumed value of an average refractive index and the input film thickness value. Here, as the assumed value of the average refractive index, those described in a polymer handbook (JOHN WILEY & SONS, INC), and catalogues of various optical films may be used. Unknown average refractive index values may be measured by an Abbe refractometer.

The average refractive indices of a major optical film are as follows: cellulose acylate (1.48), cycloolefin polymer (1.52), polycarbonate (1.59), polymethyl methacrylate (1.49), and polystyrene (1.59). Values of nx, ny, and nz are calculated by KOBRA 21ADH by inputting an assumed value of an average refractive index and a film thickness value. From the calculated nx, ny, and nz, Nz=(nx−nz)/(nx−ny) is further calculated.

$$Equation ( A ) \\ Re ( θ ) = [ nx - \frac{ny \times nz}{( \sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}} )} ] \times \frac{d}{cos \{ {sin}^{- 1} ( \frac{sin ( - θ )}{nx} ) \}} \qquad$$

Here, the Re(θ) represents a retardation value in a direction tilted at an angle θ from a normal direction. d represents a film thickness.

Rth=((nx+ny)/2−nz)×d Equation (B)

Herein, an average refractive index n becomes necessary as a parameter. As the average refractive index n, a value measured by an Abbe refractometer (Abbe refractometer 2-T, manufactured by ATAGO CO., LTD.) may be used.

(Plane Orientation Coefficient of Surface)

From the viewpoint of an adhesion with a polarizer, a plane orientation coefficient of at least one side surface of the optical film is 1.0×10⁻³ or less, is preferably 0.5×10⁻³ or less, more preferably 0.3×10⁻³ or less.

In order to obtain a plane orientation coefficient (a surface orientation coefficient) of the surface of the optical film, a refractive index at a wavelength of 532 nm was measured using a prism coupler (MODEL2010 Prism Coupler: manufactured by Metricon), and a plane orientation coefficient (P) of the surface was calculated according to the following equation from nx (a maximum in-plane refractive index), ny (a refractive index in a direction orthogonal to nx), and nz (a refractive index in a thickness direction).

P=(nx+ny)/2−nz

A method of controlling a plane orientation coefficient of a surface will be described.

In the present invention, by bringing an optical film into contact with a solvent, the plane orientation coefficient of the surface may be preferably 1.0×10⁻³ or less. As the solvent, an organic solvent is preferred.

A method of manufacturing the optical film of the present invention may be preferably an optical film manufacturing method in which an optical film containing a cyclic olefin-based resin is stretched, and the optical film is brought into contact with a solvent so that the plane orientation coefficient of the surface becomes 1.0×10⁻³ or less. The optical film is preferably stretched before brought into contact with the solvent.

[Step of Bringing Film into Contact with Organic Solvent (Organic Solvent Contact Step)]

An organic solvent is brought into contact with the surface of an optical film containing a cyclic olefin-based resin, and is dried so as to form an adhesion layer. Such adhesion improvement may be effectively applied, in particular, in an optical film containing a cyclic olefin-based resin with an advanced orientation. Accordingly, in a case where the organic solvent is brought into contact with only one surface of the optical film, and the optical film is directly bonded to a polarizer, it is preferable that the surface brought into contact with the organic solvent is set as a surface to be bonded to the polarizer. The organic solvent contact step may be performed after a film-forming step or a wet stretching step, or before and/or after a dry stretching step or a heat treatment step, and may be more preferably performed after a stretching step. Before or after the organic solvent contact step, it is preferable that a surface treatment is suitably combined.

(Organic Solvent)

The organic solvent used in the organic solvent contact step preferably contains a solvent good for a cyclic olefin-based resin, as a main solvent, and also a main solvent that may be used for a cyclic olefin-based resin solution in the solution casting film-forming step of the cyclic olefin-based resin may be preferably used.

While not being bound by any theory, it is thought that an adhesion with a polarizer is improved by bringing an optical film before an organic solvent contact step into contact with an organic solvent because an orientation of the cyclic olefin-based resin in the thickness direction is disturbed and thus a brittleness in the thickness direction is improved (a delamination is suppressed). Meanwhile, when the orientation of the cyclic olefin-based resin is disturbed, a retardation is changed. Thus, it is preferable that no disturbance occurs in the orientation of the bulk of the optical film. Accordingly, in order to achieve both a retardation development and an adhesion with a polarizer, on at least one surface of the optical film, it is important that an in-plane orientation from the surface to a depth of 0 μm to 3 μm is set to be lower than an in-plane orientation to a depth of 3 μm to 10 μm. Such an optical film may be manufactured by using, for example, a solvent of which a solubility in a cyclic olefin-based resin, a volatility (drying property), and a permeability for an optical film containing a cyclic olefin-based resin are suitably adjusted, as a main solvent used in an organic solvent contact step, or may be manufactured by adjusting a drying speed to a suitable speed in a drying step after the organic solvent contact step.

As the organic solvent, preferably, methyl acetate, ethyl acetate, methyl ethyl ketone, methyl isobutyl ketone, anon, and toluene may be exemplified.

(Contact Step)

As a method of bringing the optical film into contact with the organic solvent in the organic solvent contact step, conventionally known contact methods such as a dip coating method, an air knife coating method, a curtain coating method, a roller coating method, a wire bar coating method, a gravure coating method, a slide coating method, a spray method, and a die coating method, or an extrusion coating method using a hopper described in a specification of U.S. Pat. No. 2,681,294, and a micro gravure coating method may be used. In a steam contact step, instead of water as a main solvent, an organic solvent may be used for contact. Here, in order to effectively form an adhesion layer, the concentration of the organic solvent to be brought into contact with the optical film is preferably higher than a solvent concentration in the optical film before coming in contact with the organic solvent.

The residual solvent amount of the optical film before coming in contact with the organic solvent is not particularly limited, but preferably ranges from 0 mass % to 10 mass %, more preferably from 0 mass % to 5 mass %, further preferably from 0 mass % to 2 mass % in view of a retardation development.

The contact amount of the organic solvent (an application amount) in the organic solvent contact step is not particularly limited, but preferably ranges from 0.5 mL to 30 mL per 1 m², more preferably from 1 mL to 15 mL, further preferably from 2 mL to 10 mL. The contact amount of 0.5 mL or more per 1 m² is preferred because an adhesion may be sufficiently achieved, or a uniform contact may be made without unevenness, and the contact amount of 30 mL or less is preferred because a drying load may be reduced, a retardation change after the organic solvent contact may be suppressed, or a curling of a film may be reduced.

(Drying Step)

The optical film that has come in contact with the organic solvent as described above is then conveyed to a drying zone, and conveyed through a roll group, and then the drying step is completed while, preferably, both ends of the film are clipped in a tenter. When the organic solvent contact step is performed before the dry stretching step or the heat treatment step, these steps may be drying steps. As a drying method, a method of applying a hot wind or a warm wind, or a wind with a low gas concentration to the conveyed optical film, a method of irradiating heat rays, a method of bringing the film into contact with a heated roll or the like may be exemplified, but a method of applying a hot wind or a warm wind, or a wind with a low gas concentration is preferred. The temperature of the drying wind is not particularly limited, but preferably ranges from −10° C. to 140° C., more preferably from 25° C. to 120° C., further preferably from 30° C. to 100° C., most preferably from 40° C. to 80° C. When the drying temperature is −10° C. or more, the film may be dried at a sufficient drying speed, and at 140° C. or less, an adhesion may be effectively improved.

It is preferable that the residual solvent amount of the optical film which has been completely dried as described above is equal to or less than the residual solvent amount of the optical film before coming in contact with the organic solvent. When the organic solvent contact step is performed after the dry stretching step or the heat treatment step, the residual solvent amount preferably ranges from 0 mass % to 5 mass %, more preferably from 0 mass % to 3 mass %, further preferably from 0 mass % to 2 mass %, most preferably from 0 mass % to 1 mass %. Here, a ratio (W₁/W₀) of the weight (W₀) of the optical film before coming in contact with the organic solvent to the weight (W₁) of the optical film after the drying step is not particularly limited, bur preferably ranges from 0.97 to 1.03, more preferably from 0.98 to 1.02, further preferably from 0.99 to 1.01 in view of curling reduction of the dried film.

A ratio (Re₁/Re₀) of the retardation (Re₀) of the optical film before coming in contact with the organic solvent to the retardation (Re₁) of the optical film after the drying step is not particularly limited, but preferably ranges from 0.8 to 1.2, more preferably from 0.9 to 1.1, further preferably from 0.95 to 1.05. In this range, a planar shape may be good in many cases.

A ratio (HZ₁/HZ₀) of the haze (HZ₀) of the film before coming in contact with the organic solvent to the haze (HZ₁) of the optical film after the drying step is not particularly limited, but preferably ranges from 0.1 to 1.5, more preferably from 0.3 to 1.4, further preferably from 0.5 to 1.3. The haze (HZ₁) of the dried optical film is preferably 1.0% or less, more preferably 0.7% or less, further preferably 0.5% or less. Within such a range, when the optical film is loaded in a liquid crystal display device, it is possible to reduce a light leakage during a black display, and further to suppress bleeding-out of an additive in the film or bleeding-out of an additive with elapse of time so as to suitably adjust an adhesion with a polarizer.

(Surface Hydroxyl Group Content)

In view of an adhesion with a polarizer, on the surface of the optical film with a plane orientation coefficient of 1.0×10⁻³ or less, a surface hydroxyl group content is 1.5% or more, and preferably 3.0% or more.

The surface hydroxyl group content (a surface hydroxyl group number) is measured by the following method.

According to the description in JSR TECHNICAL REVIEW NO. 19/2012 (polymer film surface analysis by chemical modification), trifluoroacetic anhydride was used to react a sample of an optical film with trifluoroacetic anhydride, and then, XPS (X-ray photoelectron spectroscopy) analysis was performed. The surface hydroxyl group number (ROH) was calculated according to the following equation.

ROH=fluorine amount of measurement sample [atomic %]/(3×carbon amount of measurement sample [atomic %])×reaction rate×100

Hereinafter, a method of controlling a surface hydroxyl group content of an optical film will be described.

The optical film preferably has a surface hydroxyl group content of 1.5% or more through a plasma treatment.

Preferably, a method of manufacturing the optical film of the present invention is an optical film manufacturing method in which an optical film containing a cyclic olefin-based resin is stretched, and the optical film is subjected to the plasma treatment so that the surface hydroxyl group content is 1.5% or more. The optical film is preferably stretched before the plasma treatment.

[Plasma Treatment]

As a plasma treatment, a plasma treatment using a vacuum glow discharge, an atmospheric pressure glow discharge or the like may be exemplified, and as another method, a method such as a flame plasma treatment may be exemplified. For these treatments, for example, methods described in Japanese Patent Laid-Open Publication No. H6-123062, H11-293011, H11-005857 and the like may be employed.

The plasma treatment on a surface of a plastic film in the plasma may give a strong hydrophilicity to the surface. For example, in a plasma generating apparatus using the glow discharge described above, a film to which such a hydrophilicity is given is placed between opposing electrodes, and a plasma excitation gas is introduced to the apparatus to apply a high frequency voltage between the electrodes such that the gas is plasma-excited to perform a glow discharge between the electrodes, and then the surface treatment is performed. Among them, a treatment using an atmospheric pressure glow discharge is preferably used.

A plasma excitable gas refers to a plasma-excited gas under the condition as described above, and argon, helium, neon, krypton, xenon, nitrogen, carbon dioxide, fluorocarbons such as tetrafluoromethane, and mixtures thereof may be exemplified.

As such a gas, an inert gas such as argon, neon or the like, added with a reactive gas that may provide a polar functional group such as a carboxyl group or a hydroxyl group, or a carbonyl group to a surface of a plastic film may be used as an excitation gas. As the reactive gas, besides a gas such as hydrogen, oxygen, nitrogen, water vapor or ammonia, a low-boiling point organic compound such as lower hydrocarbon, ketone or the like also may be used as required, but in view of handling, a gas such as hydrogen, oxygen, carbon dioxide, nitrogen, water vapor is preferred. When the water vapor is used, a bubbled gas obtained by passing another gas through water may be used. Otherwise, water vapor may be mixed.

A frequency of a high frequency voltage to be applied preferably ranges from 1 kHz to 100 kHz, more preferably from 1 kHz to 10 kHz.

Such a plasma treatment using a glow discharge may be performed under vacuum or atmospheric pressure.

In the vacuum plasma discharge treatment using a glow discharge, it is necessary to introduce the reactive gas such that the atmosphere is maintained in a range of 0.005 torr to 20 torr in order to effectively cause a discharge. In order to increase a processing speed, it is preferable to employ a high output condition at a highest possible pressure side. However, when the electric field intensity is excessively increased, a substrate may be damaged.

1 torr is 133.322 Pa.

In a case of an atmospheric pressure glow discharge for performing a plasma discharge near an atmospheric pressure, an inert gas such as helium or argon is required to stably cause a discharge. When 60% or more of the plasma excitation gas is not an inert gas, a stable discharge does not occur. However, when the amount of the inert gas is too large, and the ratio of the reactive gas is small, the processing speed is lowered. Also, when the electric field intensity is excessively increased, a substrate may be damaged.

Even in a case where a plasma treatment is performed near an atmospheric pressure, when the plasma is generated in a pulsed electrolysis, the inert gas is not necessary, while the reactive gas concentration may be increased, thereby increasing the reactive speed.

In the flame plasma treatment, a flame treatment is performed on a surface of a film to be subjected to a surface treatment by a burner, and thus plasma is generated so that the surface treatment is performed. A mixed gas containing a combustion gas such as a paraffinic gas (city gas, natural gas, methane gas, propane gas, butane gas, etc.) mixed with an oxidizing gas such as air or oxygen (besides, a combustion improver or an oxidizing agent may be used) is burned and the resultant flame is used for the surface treatment.

In general, a flame exiting from a burner includes an external flame and an internal flame. The external flame portion is a high temperature portion in which an unreacted (incompletely combusted) gas of the internal flame is heated, which is a portion generally with a light blue color and is a so-called blue gas flame. A flame portion that is not blue is a portion in which an oxygen supply is small and a temperature is relatively low in the internal flame.

A large amount of plasma is generated in the flame in a range of 30 mm from the distal end of the internal flame. As described in detail in Japanese Patent Laid-Open Publication No. H11-184042, when a flame is limited by a shielding plate, a substrate surface may be treated with a limited flame of a portion in a range of 30 mm from the distal end of the internal flame, so that a plasma treatment is performed.

The time the flame is applied is a time the substrate to be treated is in contact with the flame, which ranges from 0.001 sec to 2 sec, and preferably from 0.01 sec to 1 sec. When the time is too long, the surface is excessively invaded, and when the time is too short, an oxidation reaction hardly occurs so that the adhesion is not improved.

The burner used for this purpose only has to uniformly apply a flame to the surface of a substrate to be subjected to the plasma treatment. A plurality of burners may be arranged.

A mixing ratio of the combustion gas and the oxidizing gas for the flame treatment varies according to the kinds of gases. For example, in a case of a propane gas and air, a preferred mixing ratio of propane gas/air may range from 1/15 to 1/22 in a volume ratio, and preferably from 1/16 to 1/19, and in a case of natural gas and air, a mixing ratio ranges from 1/6 to 1/10, and preferably from 1/7 to 1/9. The size ratio of the internal flame and the external flame varies according to the type of the combustion gas or the type of the oxidizing gas, the mixing ratio, the feed rate or the like.

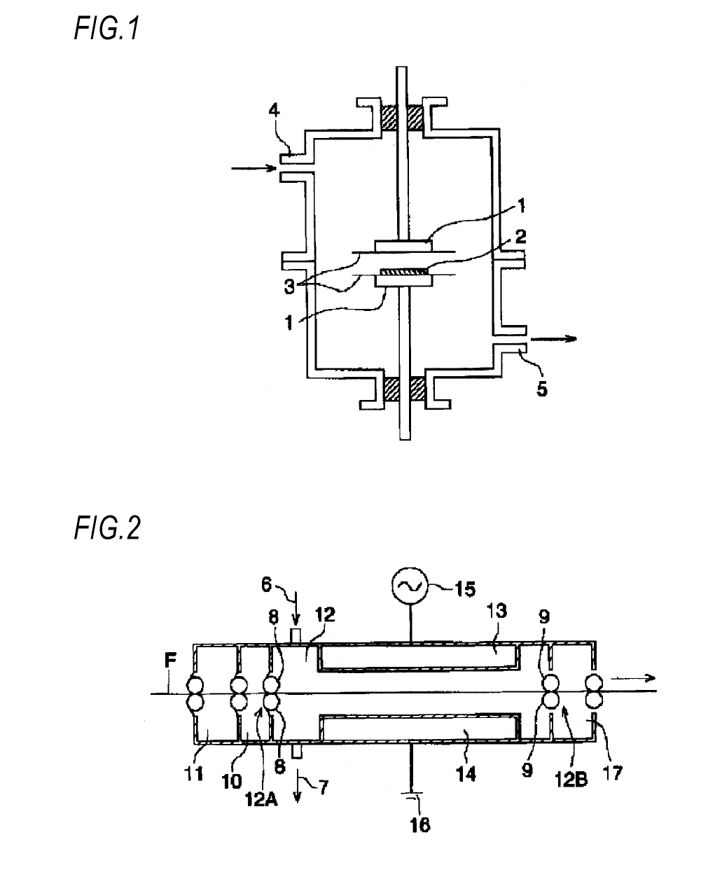

As an example of such a plasma treatment apparatus, an atmospheric pressure plasma treatment apparatus is exemplified in FIG. 1, and an apparatus for continuously performing a vacuum plasma treatment is exemplified in FIG. 2.

FIG. 1 is a sectional view illustrating an example of an atmospheric pressure plasma treatment apparatus. That is, in the atmospheric pressure plasma generating apparatus of FIG. 1, a sample 2 to be subjected to a plasma treatment is placed between two opposing electrodes (both upper and lower electrodes are illustrated in FIG. 1). In order to suppress a spark discharge from occurring at the plasma excitation, a dielectric 3 such as a glass, ceramic or polyimide film may be preferably provided on the surface of the upper and/or lower electrode. A plasma excitation gas such as a mixed gas of argon and helium is introduced from an inlet 4 to the atmospheric pressure plasma generating apparatus, and is discharged from an outlet 5 by replacing an internal air. Then, a high frequency voltage of, for example, 3000 Hz, 4200 V is applied between the electrodes, and the introduced gas is plasma-excited so that a glow discharge occurs for a predetermined time to perform modification of the sample surface.

FIG. 2 is a sectional view illustrating an example of an apparatus for continuously performing a vacuum plasma treatment, in which a processing unit is constituted by a processing chamber 12 with partitions having an inlet 12A and an outlet 12B of a sample film F. The processing unit is configured to continuously perform a plasma treatment under vacuum on an elongated film that is continuously conveyed.

In the processing chamber 12, opposing flat plate electrodes 13 and 14 are provided. Among the pair of electrodes 13 and 14, one electrode 13 is connected to a high frequency power supply 15 and the other electrode is grounded by an earth 16, so that an electric field is applied between the pair of electrodes 13 and 14.

A processing gas is introduced to an introducing port 6, and the inside of the processing chamber is evacuated through an exhaust port 7 by an exhaust pump.

In the example of FIG. 2, preliminary vacuum chambers 10 and 11 are provided adjacent to the processing chamber 12, at the inlet side of the film. A preliminary vacuum chamber 17 is also provided adjacent to the processing chamber 12 at the outlet side of the film. These partitions are made by nip rolls 8 and 9, but not limited thereto. Here, reference numeral 15 indicates a high frequency power supply.

When the preliminary vacuum chambers are provided, as illustrated, two may be provided at the inlet side of the film F, and one may be provided at the outlet side, but the present invention is not limited thereto. It may be considered that one chamber may be attached to each of the inlet and outlet of the film F, or two chambers may be attached to each of the inlet and outlet.

As an apparatus for performing a flame plasma treatment, an apparatus described in Japanese Patent Laid-Open Publication No. H9-355097 is preferably used.

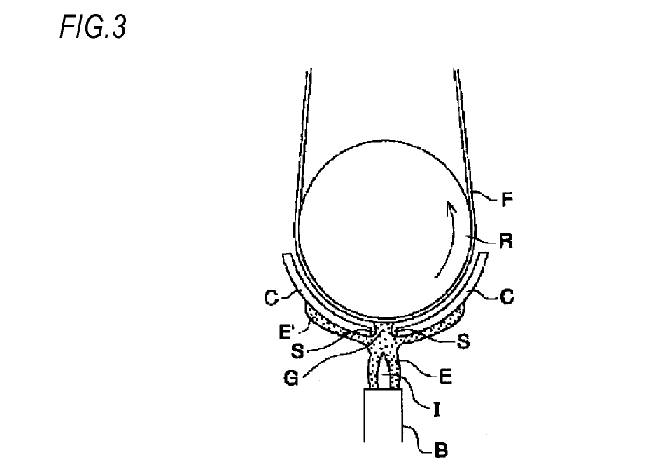

FIG. 3 illustrates an example of a plasma treatment apparatus using a flame treatment. In general, a flame exiting from a burner includes an external flame and an internal flame. The external flame portion is a high temperature portion in which an unreacted (incompletely combusted) gas of the internal flame is heated, which is a portion generally with a light blue color and is a so-called blue gas flame. A flame portion that is not blue is a portion in which an oxygen supply is small and a temperature is relatively low in the internal flame

The external flame includes a large amount of flame unnecessary for the plasma treatment. Also, when the external flame spreads, the processing cannot be controlled. Thus, a shielding plate (an external flame regulation device) C illustrated in FIG. 3 is provided to control a flame treatment so as to achieve a purpose, by which an unwanted external flame E′ is put out of the shielding plate (the external flame regulation device) C to avoid a support, and an effective flame (regulated flame) G is allowed to come in contact with the surface of a sample film F. In the drawing, a burner B, an external flame E, an internal flame I, the external flame E′ shielded at the outside of the shielding plate and spread, the effective flame G, an effective processing port (slit) S and the like are illustrated, in which the effective flame G is allowed to come in contact with the surface of the sample film F through the effective processing port (slit) S.

(Polarizing Plate)

A polarizing plate employing the optical film of the present invention includes at least one layer of the optical film of the present invention as a protective film, and at least one layer of a polarizer. The optical film of the present invention may be arranged closer to a cell side than the polarizer in the bonding with a liquid crystal cell, and thus have a function of an optically compensatory film. Also, the polarizer may be arranged at a cell side. Also, it is possible to employ a multi-layered configuration in which the surface of the optical film of the present invention is provided with the above described functional layer or has been subjected to the above described surface treatment.

When one layer of polarizing plate protective film is further employed in the polarizing plate having at least one layer of the optical film of the present invention, a proper transparent film may be used as the protective film. In particular, a cellulose acetate-based film, an acrylic film, a PET (polyethylene terephthalate) film or the like may be preferably used.

In a configuration having two or more layers of the optical films of the present invention, the respective films may be the same optical films or different optical films.

The polarizing plate may be manufactured by a general method. There is a method in which the surface of the polarizing plate protective film of the present invention is subjected to a corona treatment, and is bonded to both surfaces of a polarizer manufactured by dipping a polyvinyl alcohol film in an iodine solution and stretching the dipped film by using a completely saponified polyvinyl alcohol aqueous solution. Instead of the corona treatment, an easy-to-bond processing as described Japanese Patent Laid-Open Publication No. H6-94915, and Japanese Patent Laid-Open Publication No. H6-118232 may be performed. Also, a surface treatment such as the above described alkali treatment may be performed.

As an adhesive used for bonding the treatment surface of a polarizing plate protective film and a polarizer, for example, a polyvinyl alcohol-based adhesive such as polyvinyl alcohol or polyvinyl butyral, a vinyl latex such as butylacrylate, a UV curable adhesive, a thermosetting adhesive or the like may be exemplified.

The optical film of the present invention and the polarizer may be bonded to each other by another adhesive or a sticking agent, and may be directly layered on top of each other without an adhesive or a sticking agent interposed therebetween within a range that does not cause a practical problem such as peeling.

Properties of the polarizing plate employing the optical film of the present invention may be adjusted as required according to properties of the optical film of the present invention or another polarizing plate protective film used in combination. For example, when a warpage occurs in a polarizing plate, in order to prevent the warpage, it is preferable to adjust a film thickness of each of the optical film of the present invention and another polarizing plate protective film.

(Image Display Device)

The image display device of the present invention is characterized in that it has the optical film of the present invention and the polarizing plate using the same. The image display device of the present invention may be preferably used in a liquid crystal display device, an organic EL display or the like. As the liquid crystal display device, a VA system or an IPS system is known, and the optical film of the present invention and the polarizing plate using the same may be preferably used in a wide range such as a large TV, a PC monitor, a note PC, a small and medium size tablet PC, a mobile phone and the like as applications.

### EXAMPLE

### Synthesis Example 1

8-methyl-8-methoxycarbonyltetracyclo[4.4.0.1^{2,5}.1^{7,10}]-3-dodecene (100 parts by mass), 1-hexene (4.6 parts by mass) of a molecular weight modifier, and toluene (200 parts by mass) were charged to a nitrogen-purged reaction vessel and heated up to 80° C. A toluene solution 0.18 ml of triethylaluminum (0.6 mol/L), and a toluene solution (0.58 ml) of methanol modified WCl₆ (0.025 mol/L) were added thereto, and reacted at 80° C. for 3 hours to obtain a polymer. Subsequently, the obtained ring-opening copolymer solution was charged in an autoclave, and then toluene (200 parts by mass) was added. RuHCl(CO)[P(C₆H₅)]₃ (2500 ppm) which is a hydrogenation catalyst was added with respect to the charged amount of monomers, the hydrogen gas pressure was set to 9 MPa to 10 MPa, and then a 3-hour reaction was performed at 160° C. to 165° C. After the reaction was completed, the resultant product was precipitated in a large amount of a methanol solution to obtain a hydrogenated product (resin 1). The obtained hydrogenated product of the ring-opening polymer had a weight average molecular weight (Mw)=135×10³, and a molecular weight distribution (Mw/Mn)=3.1.

### Synthesis Examples 2 to 14

Resins 2 to 14 were obtained in the same manner as in Synthesis Example 1 except that the amounts of 8-methyl-8-methoxycarbonyltetracyclo[4.4.0.1^{2,5}.1^{7,10}]-3-dodecene (a monomer, 100 parts by mass), and 1-hexene (4.6 parts by mass) were changed to those noted in Table 1.

TABLE 1

| | 8-methyl-8- | 8-methyl-8- | 8-methyl-8-n- |
|---|---|---|---|
| | methoxycarbonyltetra- | ethoxycarbonyltetra- | butoxycarbonyltetra- |
| | cyclo[4.4.0.1^{2,5}.1^{7,10}]-3- | cyclo[4.4.0.1^{2,5}.1^{7,10}]-3- | cyclo[4.4.0.1^{2,5}.1^{7,10}]-3- |
| | dodecene | dodecene | dodecene |
| | 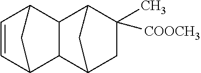 [SMILES: COC(=O)C1(C)CC2CC1C1C3C=CC(C3)C21] | 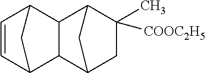 | 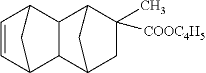 |
| | Parts by mass | Party by mass | Party by mass |
| Resin 1 | 100.0 | 0.0 | 0.0 |
| Resin 2 | 0.0 | 100.0 | 0.0 |
| Resin 3 | 28.8 | 71.2 | 0.0 |
| Resin 4 | 0.0 | 0.0 | 100.0 |
| Resin 5 | 45.8 | 0.0 | 54.2 |
| Resin 6 | 72.5 | 0.0 | 0.0 |
| Resin 7 | 59.0 | 0.0 | 0.0 |
| Resin 8 | 90.8 | 0.0 | 0.0 |
| Resin 9 | 76.5 | 0.0 | 0.0 |
| Resin 10 | 48.5 | 51.5 | 0.0 |
| Resin 11 | 77.2 | 0.0 | 22.8 |
| Resin 12 | 87.5 | 0.0 | 0.0 |
| Resin 13 | 95.7 | 0.0 | 0.0 |
| Resin 14 | 84.8 | 0.0 | 0.0 |

| | | | 5-methoxycarbonyl- | | |
|---|---|---|---|---|---|
| | | | 5-methyl- | | |
| | dicyclo- | bicyclo[2.1.1] | bicyclo[2.1.1] | | |
| | pendadiene | hept-2-ene | hept-2-ene | | |
| | 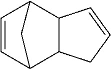 | 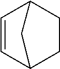 | 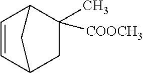 | 1-hexene | Mw |
| | Parts by mass | Parts by mass | Parts by mass | Parts by mass | [x1000] |
| Resin 1 | 0.0 | 0.0 | 0.0 | 4.6 | 135 |
| Resin 2 | 0.0 | 0.0 | 0.0 | 4.3 | 143 |
| Resin 3 | 0.0 | 0.0 | 0.0 | 4.4 | 141 |
| Resin 4 | 0.0 | 0.0 | 0.0 | 3.9 | 159 |
| Resin 5 | 0.0 | 0.0 | 0.0 | 4.2 | 148 |
| Resin 6 | 27.5 | 0.0 | 0.0 | 5.6 | 119 |
| Resin 7 | 41.0 | 0.0 | 0.0 | 6.0 | 111 |
| Resin 8 | 0.0 | 9.2 | 0.0 | 5.2 | 128 |
| Resin 9 | 0.0 | 0.0 | 23.5 | 5.0 | 126 |
| Resin 10 | 0.0 | 0.0 | 0.0 | 4.5 | 139 |
| Resin 11 | 0.0 | 0.0 | 0.0 | 4.4 | 141 |
| Resin 12 | 12.5 | 0.0 | 0.0 | 5.0 | 128 |
| Resin 13 | 0.0 | 4.3 | 0.0 | 4.9 | 132 |
| Resin 14 | 0.0 | 0.0 | 15.2 | 4.9 | 129 |

### Example 1

Resin 1 obtained in Synthesis Example 1, as a dope for a layer A, was dissolved in methylene chloride to prepare a solution with a solid concentration of 25 mass %. Resin 2 obtained in Synthesis Example 2, as a dope for a layer B, was dissolved in methylene chloride to prepare a solution with a solid concentration of 25 mass %.

Then, the solutions were casted on a metal support through a casting gieser capable of co-casting three layers. Here, the casting was performed such that a layer B, a layer A, and a layer B were arranged in this order from a metal support surface side. Here, a film thickness of the layer A was set to 38 μm, and a film thickness of each of the layers B was set to 1 μm. While being present on the metal support, the dopes were dried by a drying wind of 40° C. to form a film, and the film was peeled. While both ends of the film were fixed by clips and the interval between them was maintained at a constant interval, the film was dried for 5 min by a drying wind of 120° C. After the clips were removed, the film was dried again at 150° C. for 20 min to obtain film 1 that is the optical film of the present invention (a cyclic olefin-based resin film). Tg of each of the layer A and the layer B in the obtained film is noted in Table 2.

### Example 2 to 18, Comparative Examples 1 to 12

Films 2 to 30 were obtained in the same manner as in Example 1 except that resins used for a layer A and a layer B and film thicknesses were changed to those noted in Table 2. In a case of films 19 to 29, a single layer film was deposited by using only a central portion of a casting gieser capable of co-casting three layers.

<Measurement Method of Glass Transition Temperature (Tg) of Layer A and Layer B>

Tg of each layer was measured using a differential scanning calorimeter after a film was cut out and a single film member of each layer was taken out. Specifically, the measurement was performed using a differential scanning calorimeter DSC7000X (manufactured by Hitachi High-Tech Science Inc.) under a nitrogen atmosphere at a heating rate: 20° C./min, and a peak top temperature of a time differential DSC curve (DDSC curve) of the obtained result was obtained, and a temperature at a point where a tangent of each DSC curve intersects at the peak top temperature of −20° C. was obtained as Tg.

<Evaluation of Film Dimensional Change Rate>

On the obtained film, a dimensional change rate before and after elapsed time of 24 hours at 120° C. (RH of less than 5%), that is, a value of (L′−L0)/L0}×100%, was obtained with respect to a width direction of the film. Here, L0 described above indicates a film length (unit: mm) before elapsed time of 24 hours at 120° C., and L′ indicates a film length (unit: mm) after elapsed time of 24 hours at 120° C., and further after elapsed time of 2 hours at 25° C., and RH of 60%. The size of the used sample film was 30 mm×120 mm, and other conditions were as follows.

The film was humidified for 2 h or more under an atmosphere of 25° C. and RH 60%, and holes with a diameter of 6 mm were punched with intervals of 100 mm to parallel to 120 mm sides of the film. Then, the full scale (L0) of the interval was measured to the minimum scale of 1/1000 mm using an automatic pin gauge (manufactured by Shinto Scientific Co., Ltd.). Then, the film was left at 120° C. after 24 hours, and humidified for 2 h under an atmosphere of 25° C. and RH 60%. The dimension L′, that is, the interval of punched holes, was measured. The dimensional change rate of each film is noted in Table 2.

<Evaluation of Peeling Force>

(Manufacturing of Polarizer)

A polyvinyl alcohol film with a thickness 75 μm that is composed of polyvinyl alcohol (an average degree of polymerization: about 2400, saponification degree: 99.9 mol % or more) was immersed in pure water of 30° C., and then immersed in an aqueous solution of iodine/potassium iodide/water (mass ratio: 0.02/2/100) at 30° C. Then, it was immersed in an aqueous solution of potassium iodide/boric acid/water (mass ratio: 12/5/100) at 56.5° C.

Then, the film was washed with pure water of 8° C., and dried at 65° C. to obtain a polarizer in which iodine was adsorbed and oriented in the polyvinyl alcohol film. The stretching was performed mainly in, steps of iodine staining and boric acid treatment, and the total stretching ratio was 5.3 times.

(Preparation of Aqueous Adhesive)

Acetoacetyl group-modified polyvinyl alcohol (Gohsefimer Z-200 manufactured by Nippon Synthetic Chemical Industry Co., Ltd., viscosity of aqueous solution of 4 mass %=12.4 mPa·sec, saponification degree=99.1 mol %) was dissolved in pure water to prepare an aqueous solution of 10 mass % concentration. The acetoacetyl group-modified polyvinyl alcohol aqueous solution and sodium glyoxylate as a crosslinking agent were mixed with each other such that a solid mass ratio of the former:the latter became 1:0.1, and the resultant mixture was distilled with pure water such that the amount of acetoacetyl group-modified polyvinyl alcohol became 2.5 parts by mass with respect to 100 parts by mass of water. Thus, an adhesive composition was prepared.

(Bonding)

One surface of each of the cyclic olefin-based resin films 1 to 30 was subjected to a corona discharge irradiation under a condition of 400 W·min/m² using VE1A-A manufactured by VETAPHONE, and bonded to one side surface of the polarizer using the aqueous adhesive manufactured as described above. To the other side surface of the polarizer, a saponified triacetyl cellulose film was bonded.

The saponified triacetyl cellulose film was manufactured as follows. FUJITAC TD80UL (manufactured by Fuji Photo Film Co., Ltd.) was immersed in an aqueous solution of sodium hydroxide (saponification solution, 4.5 mol/L) with a controlled temperature of 37° C. for 1 min, and then the film was washed. Then, the film was immersed in a sulfuric acid aqueous solution of 0.05 mol/L for 30 sec, and then passed through a water washing bath. Then, draining was repeated three times by an air knife, and water was dropped to the film. The film was stayed in a drying zone of 70° C. for 15 sec and dried. Thus, the saponified triacetyl cellulose film was manufactured.

(Measurement of Peeling Force)

The cyclic olefin-based resin film surface of the manufactured polarizing plate was subjected to a corona treatment, and an acrylic sticking agent sheet was bonded to the corona-treatment surface. The obtained polarizing plate attached with the sticking agent was cut into a test piece having a width of 25 mm, and a length of about 200 mm, and the sticking agent surface was bonded to a soda glass. The resultant test piece was subjected to a pressurizing treatment in an autoclave at a pressure of 5 kgf/cm², and a temperature of 50° C. for 20 min, and left again under an atmosphere of 23° C. and RH 60% for 1 day. In this state, by using a tensile tester (RTF-1210 manufactured by A & D Company Ltd.), while the triacetyl cellulose film and the polarizer at one longitudinal direction end of the test piece (each side with a width of 25 mm) were grasped, a 90° peeling test was performed, under an atmosphere of 23° C. and RH 60%, at a crosshead speed (grasp moving speed) of 200 mm/min (in accordance with JIS K 6854-1: 1999 “adhesives—peel and adhesion strength test method—Part 1: 90 degree peel”). The test results on an adhesion force between the cyclic olefin-based resin film and the polarizer are noted in Table 2. In a case where the cyclic olefin-based resin film and the polarizer did not peel off, the tested value exceeds a measurement upper limit, and thus is expressed as >10 N.

TABLE 2

| | | | | | | Film | | |
|---|---|---|---|---|---|---|---|---|
| | | | | | | thickness | | |
| | | | | | | configura- | Dimen- | Polarizer |
| | | | | | | tion (μm) | sional | peeling |
| | | Layer A | | Layer B | | layer B/ | change | force |
| | | | Tg | | Tg | layer A/ | rate | (N/25 |
| | | Polymer | (° C.) | Polymer | (° C.) | layer B | (%) | mm) |
| Example 1 | Film 1 | Resin 1 | 167 | Resin 2 | 130 | 1/38/1 | −0.07 | >10 |
| Example 2 | Film 2 | Resin 1 | 167 | Resin 3 | 141 | 1/38/1 | −0.07 | 2.5 |
| Example 3 | Film 3 | Resin 1 | 167 | Resin 4 | 70 | 1/38/1 | −0.19 | >10 |
| Example 4 | Film 4 | Resin 1 | 167 | Resin 5 | 119 | 1/38/1 | −0.14 | >10 |
| Example 5 | Film 5 | Resin 1 | 167 | Resin 6 | 139 | 1/38/1 | −0.07 | 3.5 |
| Example 6 | Film 6 | Resin 1 | 167 | Resin 7 | 133 | 1/38/1 | −0.07 | 6.2 |
| Example 7 | Film 7 | Resin 1 | 167 | Resin 8 | 137 | 1/38/1 | −0.07 | 3.7 |
| Example 8 | Film 8 | Resin 1 | 167 | Resin 9 | 144 | 1/38/1 | −0.06 | 2.3 |
| Example 9 | Film 9 | Resin 12 | 153 | Resin 2 | 130 | 1/38/1 | −0.12 | 6.1 |
| Example 10 | Film 10 | Resin 12 | 153 | Resin 7 | 133 | 1/38/1 | −0.12 | 5.3 |
| Example 11 | Film 11 | Resin 12 | 153 | Resin 9 | 144 | 1/38/1 | −0.11 | 2.3 |
| Example 12 | Film 12 | Resin 13 | 152 | Resin 2 | 130 | 1/38/1 | −0.13 | 5.7 |
| Example 13 | Film 13 | Resin 13 | 152 | Resin 7 | 133 | 1/38/1 | −0.13 | 5.0 |
| Example 14 | Film 14 | Resin 13 | 152 | Resin 9 | 144 | 1/38/1 | −0.12 | 2.3 |
| Example 15 | Film 15 | Resin 14 | 152 | Resin 2 | 130 | 1/38/1 | −0.13 | 6.0 |
| Example 16 | Film 16 | Resin 14 | 152 | Resin 7 | 133 | 1/38/1 | −0.13 | 5.2 |
| Example 17 | Film 17 | Resin 14 | 152 | Resin 9 | 144 | 1/38/1 | −0.12 | 2.3 |
| Example 18 | Film 18 | Resin 10 | 149 | Resin 6 | 139 | 1/38/1 | −0.16 | 3.5 |
| Comp. Ex. 1 | Film 19 | Resin 1 | 167 | — | — | —/40/— | −0.05 | 1.0 |
| Comp. Ex. 2 | Film 20 | Resin 2 | 130 | — | — | —/40/— | −0.50 | 6.0 |
| Comp. Ex. 3 | Film 21 | Resin 4 | 70 | — | — | —/40/— | −17.20 | >10 |
| Comp. Ex. 4 | Film 22 | Resin 5 | 119 | — | — | —/40/— | −1.80 | >10 |
| Comp. Ex. 5 | Film 23 | Resin 7 | 133 | — | — | —/40/— | −0.42 | 5.0 |
| Comp. Ex. 6 | Film 24 | Resin 9 | 144 | — | — | —/40/— | −0.25 | 2.2 |
| Comp. Ex. 7 | Film 25 | Resin 10 | 149 | — | — | —/40/— | −0.15 | 1.7 |
| Comp. Ex. 8 | Film 26 | Resin 11 | 148 | — | — | —/40/— | −0.15 | 1.7 |
| Comp. Ex. 9 | Film 27 | Resin 12 | 153 | — | — | —/40/— | −0.10 | 1.5 |
| Comp. Ex. 10 | Film 28 | Resin 13 | 152 | — | — | —/40/— | −0.11 | 1.5 |
| Comp. Ex. 11 | Film 29 | Resin 14 | 152 | — | — | —/40/— | −0.11 | 1.5 |
| Comp. Ex. 12 | Film 30 | Resin 2 | 130 | Resin 1 | 167 | 1/38/1 | −0.48 | 1.0 |

### Comparative Example B1

(Manufacturing of Stretched Film)

Film B1 was obtained in the same manner as in Comparative Example 1 except that a film thickness of film 19 of Comparative Example 1 was changed to 90 μm. Then, film B1 was longitudinally stretched at a stretching ratio of 40% in a longitudinal uniaxial stretching machine at a film surface temperature of 175° C., and then transversely stretched at a stretching ratio of 115% in a tenter stretching machine at a film surface temperature of 180° C. to obtain film B2.

The stretching ratio is defined by the following equation.

stretching ratio=(film length after stretching/film length before stretching−1)×100(%)

(Vacuum Plasma Treatment)

Film B2 was subjected to a surface treatment by a vacuum plasma treatment. As a vacuum plasma device, a device of desktop series of YOUTEC Inc. was used. As an atmospheric gas used for vacuum plasma, oxygen was used. A flow rate of gas was set to 100 sccm, and power was set to 420 W. Then, the vacuum plasma treatment was performed for 4 sec to obtain film B3.

### Comparative Example B2

(Contact with Organic Solvent)

Methyl acetate was coated on the surface of film B2 to a coating amount of 8.6 ml/m², using a slot die coater described in FIG. 1 of Japanese Patent Laid-Open Publication No. 2003-211052, and dried at a drying temperature of 80° C. for 2 min to obtain film B4.

(Corona Treatment)

The surface of film B4 that has come in contact with an organic solvent was subjected to a corona irradiation under a condition of 400 W·min/m² using VE1A-A manufactured by VETAPHONE Inc. to obtain film B5.

### Example B1

The surface of film B4 that has come in contact with an organic solvent was subjected to a vacuum plasma treatment in the same manner as in Comparative Example B1 to obtain film B6.

### Example B2

(Atmospheric Plasma Treatment)

The surface of film B4 that has come in contact with an organic solvent was subjected to an atmospheric pressure plasma treatment, using an atmospheric pressure plasma surface device (AP/T04) manufactured by Sekisui Chemical Co., Ltd., by nitrogen as an atmospheric gas, under conditions of power of 85 W, and irradiation dose of 50 W·min/m² to obtain film B7.

On each of the obtained films B3, B5, B6, and B7, a glass transition temperature (Tg), a film dimensional change rate, Rth (a retardation in a thickness-direction at a wavelength 590 nm), a surface orientation coefficient, and a surface hydroxyl group number were measured by the method described above. The results are noted in Table 3.

<Manufacturing of Polarizing Plate>

A polarizing plate was manufactured in the same manner as in Example 1 except that film 1 which has been subjected to a corona discharge treatment was changed to films B3, B5, B6, and B7.

(Measurement of Peeling Force)

A peeling force was obtained in the same manner as in Example 1. The results are noted in Table 3.

TABLE 3

| | | | | Dimen- | | | Surface | Polarizer | | |
|---|---|---|---|---|---|---|---|---|---|---|
| | | | | sional | | | hydroxyl | peeling | Contact | |
| | | Layer A | | change | | Surface | group | force | with | |
| | | | Tg | rate | Rth | orientation | number | (N/25 | organic | Surface |
| | | Polymer | (° C.) | (%) | (nm) | coefficient | (%) | mm) | solvent | treatment |
| Comp. | Film B3 | Resin 1 | 167 | −0.06 | 110 | 2.6 × 10⁻³ | 1.9 | 0.5 | No | Vacuum |
| Ex. B1 | | | | | | | | | | plasma |
| | | | | | | | | | | treatment |
| Comp. | Film B5 | Resin 1 | 167 | −0.06 | 110 | 0.2 × 10⁻³ | 1.1 | 1.0 | Yes | Corona |
| Ex. B2 | | | | | | | | | | treatment |
| Example | Film B6 | Resin 1 | 167 | −0.06 | 110 | 0.2 × 10⁻³ | 1.9 | >10 | Yes | Vacuum |
| B1 | | | | | | | | | | plasma |
| | | | | | | | | | | treatment |
| Example | Film B7 | Resin 1 | 167 | −0.06 | 110 | 0.2 × 10⁻³ | 3.2 | 4.0 | Yes | Atmospheric |
| B2 | | | | | | | | | | pressure |
| | | | | | | | | | | plasma |
| | | | | | | | | | | treatment |

1.-8. (canceled)

9. An optical film comprising a cyclic olefin-based resin,
wherein a glass transition temperature of the optical film is 150° C. or more,
a retardation in a thickness-direction of the optical film at a wavelength of 590 nm is 80 nm or more, and
a plane orientation coefficient of at least one surface of the optical film is 1.0×10⁻³ or less, and a surface hydroxyl group content of the surface is 1.5% or more.

10. A method of manufacturing the optical film of claim 9, comprising:
stretching the optical film containing the cyclic olefin-based resin, and bringing the optical film into contact with a solvent so that a plane orientation coefficient of the surface is 1.0×10⁻³ or less.

11. The method of manufacturing the optical film of claim 9, comprising:
stretching the optical film containing the cyclic olefin-based resin, and performing a plasma treatment on the optical film so that a surface hydroxyl group content of the surface is 1.5% or more.

12. (canceled)

13. A polarizing plate comprising the optical film of claim 9, and a polarizer.

14. (canceled)

15. An image display device comprising the polarizing plate of claim 13.
